(19) United States
(12) Patent Application Publication
(10) Pub. No.: US 2026/0142970 A1
(43) Pub. Date: May 21, 2026

(54) PERSONALIZED AUTONOMOUS DRONE

(71) Applicant: JOHNSON MANUEL-DEVADOSS, ELKRIDGE, MD (US)

(72) Inventor: JOHNSON MANUEL-DEVADOSS, Ashburn, VA (US)

(21) Appl. No.: 18/950,012

(22) Filed: Nov. 16, 2024

(51) Int. Cl. H04L 9/40; B64U 20/80; B64U 101/66; G05B 13/02; G06Q 20/20; G06Q 30/0601

(52) U.S. Cl. CPC H04L 63/0861; B64U 20/80; G05B 13/0265; G06Q 20/208; G06Q 30/0633; H04L 63/0428; B64U 2101/66; B64U 2201/10

(57) ABSTRACT

The invention pertains to a personalized autonomous drone delivery system that integrates biometric authentication for secure and efficient product collection and delivery. The system allows users to place orders from multiple vendors, with each order including product details and vendor location data for precise navigation. Biometric credentials, such as fingerprint or facial recognition, are assigned to the user for authentication. Once authenticated, the system directs an autonomous drone to pick up the purchased items from the vendor locations and deliver them to the user's address. Also supports the upload of multiple purchase orders, enabling the drone to efficiently collect items from various vendors in a single trip. The drone's route is optimized based on factors such as distance, airspace restrictions, and environmental conditions. By combining biometric security with autonomous flight, this system enhances user experience through secure, multi-stop deliveries, offering convenience, safety, and personalization in the product fulfillment process.

### TECHNICAL FIELD

The present invention pertains to the field of automated systems, specifically utilizing an unmanned aerial vehicle (UAV), or unmanned aircraft system (UAS), commonly known as a drone, is an aircraft with no human pilot, crew, or passengers on board for consumer needs. It encompasses advancements in mobile application technology for user interaction, logistics management, and autonomous operations. This invention integrates aspects of drone navigation, and community-based retail support, aiming to enhance consumer convenience experience through innovative technological solutions

### BACKGROUND

As consumer preferences increasingly shift towards convenience and immediacy, traditional shopping methods are failing to meet the evolving demands for on-demand delivery solutions. This gap results in longer wait times, increased travel for consumers, and a lack of support for local businesses. Consequently, consumers face challenges in accessing a diverse range of products efficiently while navigating the complexities of modern retail environments. There is a pressing need for an innovative solution that enhances the shopping experience by providing seamless access to goods, reducing wait times, and fostering community engagement through the support of local retailers.

In today's e-commerce landscape, consumers are often faced with the challenge of managing purchases from multiple vendors and suppliers across various platforms. The process of browsing products, comparing prices, completing purchases, and organizing the collection and delivery of orders from different vendors is cumbersome, time-consuming, and lacks efficiency. While many e-commerce platforms provide a smooth shopping experience for product selection and purchase, the subsequent steps of coordinating the delivery or pickup of products remain fragmented and require significant manual effort.

Current solutions typically require consumers to either wait for lengthy delivery times from individual vendors or manually coordinate logistics for collecting products from multiple stores, which increases the time, cost, and effort involved in the shopping experience. Furthermore, consumers are often required to interact with separate vendor systems for order fulfillment, which creates inefficiencies and complicates the process of tracking and managing multiple orders. These inefficiencies lead to a less than optimal user experience, increased operational costs, and delays in product delivery or collection.

The problem is further exacerbated by the growing trend of multi-vendor shopping, where consumers purchase products from various suppliers across e-commerce platforms, physical retail stores, and local vendors. Coordinating these multi-vendor purchases for collection or delivery adds layers of complexity and inconvenience for the user. There is also an increasing demand for autonomous delivery solutions that can simplify and expedite the process of order collection and delivery, while providing a seamless and personalized user experience.

The need, therefore, exists for an integrated solution that not only allows users to browse, compare, and purchase products from a wide array of vendors but also automates the collection and delivery of these products from different vendors, streamlining the entire post-purchase process. Additionally, there is a demand for autonomous drones capable of interacting with vendor systems, navigating to store locations, and collecting the purchased products with minimal user intervention.

The present invention (hereinafter referred to as “iChoresDrone”), addresses these challenges by providing a personalized autonomous drone system that seamlessly integrates with mobile applications and vendor systems to facilitate product browsing, order placement, and autonomous collection and delivery. This system supports both single-vendor and multi-vendor scenarios, ensuring that users can shop for products across various platforms and have their purchases collected and delivered in an efficient, automated manner. By integrating geo-coordinates for precise navigation and incorporating communication between the drone and the vendor's Point of Sale (PoS) system, iChoresDrone ensures that the right products are collected, reducing errors and improving overall delivery accuracy.

This solution provides a comprehensive, user-centric approach to modernizing the e-commerce shopping experience, addressing the critical need for a unified, efficient, and automated system to streamline product browsing, purchasing, and collection, while minimizing human intervention and maximizing convenience for the user.

In summary, the present invention addresses the significant problems faced by consumers in modern shopping, positioning itself at the intersection of technology and consumer demand. It represents a substantial advancement in shopping solutions. The associated patent is vital for protecting the unique elements of its design and operational mechanisms, ensuring a competitive edge in a rapidly evolving retail landscape and paving the way for future innovations in drone-assisted shopping.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. As consumer preferences increasingly shift towards convenience and immediacy, traditional shopping methods are failing to meet the evolving demands for on-demand delivery solutions. This gap results in longer wait times, increased travel for consumers, and a lack of support for local businesses. Consequently, consumers face challenges in accessing a diverse range of products efficiently while navigating the complexities of modern retail environments. There is a pressing need for an innovative solution that enhances the shopping experience by providing seamless access to goods, reducing wait times, and fostering community engagement through the support of local retailers.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a computing system associated with facilitating automated shopping and delivery via a personalized autonomous Drone, with integrated biometric verification for secure user authentication.

FIG. 2 illustrates principal function of the present invention associated with facilitating automated shopping and delivery via a personalized autonomous Drone, with integrated biometric verification for secure user authentication.

FIG. 3 illustrates one embodiment of a personalized autonomous Drone system associated with facilitating automated shopping and delivery via a personalized autonomous Drone, with integrated biometric verification for secure user authentication.

FIG. 4A illustrates an exemplary mobile application interface showing product browsing, according to some embodiments.

FIG. 4B illustrates an exemplary mobile application interface showing another product browsing, according to some embodiments.

FIG. 4C illustrates an exemplary mobile application interface showing checkout operation, according to some embodiments.

FIG. 4D illustrates an exemplary mobile application interface showing payment confirmation, according to some embodiments.

FIG. 4E illustrates an exemplary mobile application interface showing upload the multi purchase orders to the system, according to some embodiments.

FIG. 4F illustrates an exemplary mobile application interface showing extraction details from uploaded multi purchase orders to the system, according to some embodiments.

FIG. 5A is a flowchart that illustrates a method for facilitating automated shopping and delivery via a personalized autonomous UAV/UAS/Drone, with integrated biometric verification for secure user authentication, according to some embodiments.

FIG. 5B is flowchart that illustrates step-by-step description of the process, outlining how the system works from the user's product selection and purchase to the final delivery via the personalized autonomous drone, according to some embodiments.

FIG. 5C is flowchart that illustrates the operation of the system step-by-step, covering the user interaction, backend processes, and the autonomous drone's role in executing the final delivery, according to some embodiments.

FIG. 6 is flowchart that illustrates the step-by-step operation of the personalized autonomous drone, according to some embodiments.

FIG. 7 illustrates one embodiment of a method for biometric private key generation associated with facilitating automated shopping and delivery via a personalized autonomous UAV/UAS/Drone, with integrated biometric verification for secure user authentication.

FIG. 8 illustrates one embodiment of a method for enforcing re-registration of a compromised user identity associated with facilitating automated shopping and delivery via a personalized autonomous UAV/UAS/Drone, with integrated biometric verification for secure user authentication.

FIG. 9 illustrates an example computing system that is configured and/or programmed as a special purpose computing device with one or more of the example systems and methods associated with facilitating automated shopping and delivery via a personalized autonomous UAV/UAS/Drone, with integrated biometric verification for secure user authentication described herein, and/or equivalents.

FIG. 10 illustrates an example mobile device that is configured and/or programmed with one or more of the systems and methods associated with facilitating automated shopping and delivery via a personalized autonomous UAV/UAS/Drone, with integrated biometric verification for secure user authentication described herein, and/or equivalents.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

The present invention addresses the growing demand for convenient and efficient shopping solutions by integrating advanced drone technology with a user-friendly mobile application. This innovative system allows consumers to easily browse and order a wide variety of products, ranging from everyday groceries to specialized hardware, all while promoting local commerce and community engagement.

The present invention relates to a personalized autonomous drone system, referred to as iChoresDrone, designed to assist users in the browsing, purchasing, and collection of products through seamless integration with mobile applications and vendor systems. The embodiments are intended to streamline the user's shopping experience by combining product search, purchase, biometric verification and validation and autonomous delivery all within a personalized drone framework.

In one embodiment of the present invention is Product Browsing and Order Placement via Mobile App, the user opens the mobile app and searches for a specific product by typing a query into a search. In response, the mobile app aggregates and displays a product catalog from multiple vendors, suppliers, and e-commerce platforms, each listing their own price, availability, and product details. The present invention provides a user-friendly interface that allows users to compare products from local vendors, suppliers, and online e-commerce platforms. Also, it allows the user to review the available products and may notice price differences between various vendors. The user selects the preferred product based on factors such as price, vendor reputation, shipping options, or product specifications. After selecting a product, the user proceeds with the purchase directly within the mobile app. The app enables the user to complete the transaction by providing payment information and confirming the shipping details. Upon successful transaction, the mobile app receives an order confirmation from the vendor, which includes details about the product, price, and store location. The store location is provided in the form of geo-coordinates (latitude and longitude), ensuring precise and accurate navigation. The mobile app then transmits the order details along with the geo-coordinates to the user's personalized autonomous drone. When the user is ready to collect their order, they can activate the drone by either: Saying the voice command, “Hey iChoresDrone, go collect the package,” or pressing the button labeled “Push these orders to Drone to pick it up” within the mobile app. In response, the iChoresDrone begins its operation by plotting a navigation path to the vendor's store location using the provided geo-coordinates. The drone then communicates with the vendor's Point of Sale (PoS) system to confirm that the package is ready for pickup, ensuring that the right product is retrieved. The drone flies to the designated store location, collects the product from the vendor, and proceeds with the delivery to the user's specified address or location. The entire process is automated, requiring minimal user intervention, thus ensuring efficiency and convenience for the user.

In another embodiment of the present invention is Multi-Vendor Order Collection and Delivery, the user may visit multiple e-commerce websites or retail stores to purchase products from different vendors or suppliers. Once the user completes their purchases, they upload the purchase orders to the mobile app. These orders may originate from multiple sources, including various vendors and suppliers across different platforms. The mobile app processes the uploaded orders by parsing the data and extracting key information, including Order confirmation details (e.g., product names, quantities, and prices); Store locations (provided as geo-coordinates for each vendor). This information is then compiled into a cohesive dataset, which is transmitted to the user's personalized autonomous drone. Upon receiving the purchase order data, the drone's system generates a navigation path that includes travel routes to each vendor's store location, based on the geo-coordinates provided. Simultaneously, the drone establishes a communication channel with each vendor's PoS system to ensure that each product is ready for pickup at the designated time. The user activates the drone by either: Saying the voice command, “Hey iChoresDrone, go collect the package,” or pressing the “Push these orders to Drone to pick it up” button in the mobile app. The iChoresDrone then follows its pre-planned navigation route, visiting each vendor's store in the appropriate order and collecting the products as per the user's purchase orders. At each store, the drone confirms the order details with the vendor's PoS system and picks up the products. After collecting all of the ordered items from multiple vendors, the drone follows its navigation path to deliver the complete set of packages to the user's specified location. The entire process is autonomous, allowing for multi-vendor product collection and efficient delivery to the user, all coordinated by the personalized drone system.

Overall, the present invention represents a significant advancement in retail logistics, aiming to streamline the shopping process and improve customer satisfaction while contributing positively to local economies. The associated patent is crucial for protecting the unique design elements and operational mechanisms that distinguish this solution in a competitive marketplace, paving the way for future innovations in drone-assisted shopping.

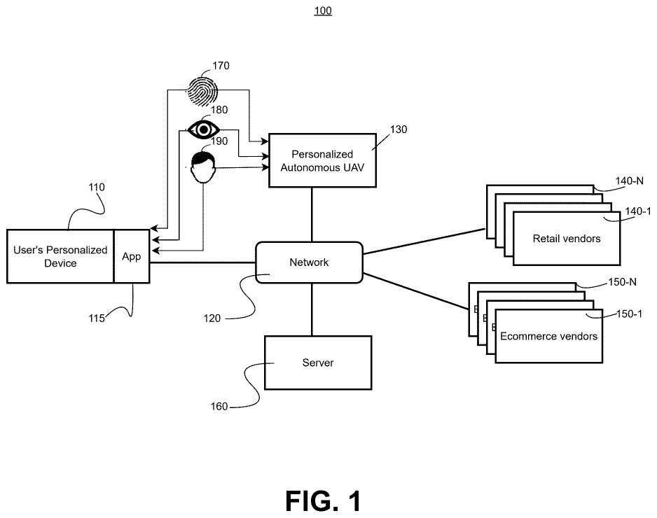

The principal operation of present invention illustrated in FIG. 1 that demonstrates a fully integrated, autonomous shopping solution, leveraging user devices, user biometric (eye retinal, fingerprinting, facial) coordinates, network infrastructure, autonomous drones, and vendor systems to streamline e-commerce operations and enhance the user experience in shopping and delivery. The present invention 100 is an interconnected platform that enables autonomous drone-based e-commerce operations by linking various components, including user devices, user biometric coordinates, drones, vendor systems, and a network infrastructure. The system facilitates the autonomous purchase, collection, and delivery of products, ensuring seamless interaction between users, retailers, and the personalized autonomous UAV. The principle operation of the present invention 100 comprises of User's Personalized Device 110, Mobile Application 115, User's Biometric co-ordinates such as Fingerprinting 170, Eye retinal 180, Facial 190, Network 120, Server 160, Personalized Autonomous unmanned aerial vehicle (UAV) 130, Retail Vendors 140-1 to 140-N, and E-commerce Vendors 150-1 to 150-N. User's Personalized Device 110 Represents the user's device, such as a smartphone or tablet, which provides access to the mobile application (i.e., iChoresDrone) platform 115. Mobile Application 115 is an application on the user's device that allows interaction with the iChoresDrone system. Through this mobile application 115, users can search for products, place orders, track deliveries, and manage other shopping-related activities. The network 120 serves as the primary communication pathway for transmitting data among different components in the system, including user devices, the personalized UAV, retail vendors, and e-commerce vendors. It supports real-time data exchange, ensuring timely and accurate order processing and delivery tracking. Server 160 manages the backend operations of iChoresDrone, processing data from the network and coordinating interactions with various vendors and the UAV. It handles requests from the user's device, processes orders, and ensures that each order is efficiently routed to the appropriate vendors. The UAV 130 is responsible for autonomously navigating to collect and deliver products. It receives instructions from the network, such as order details and delivery locations, and utilizes its autonomous navigation capabilities to fulfill user requests accurately. Retail Vendors 140-1 to 140-N represent physical or online retail stores that have integrated their systems with iChoresDrone. They can accept orders placed via the user's app, allowing the UAV to autonomously collect purchased items from these vendors for delivery. E-commerce Vendors 150-1 to 150-N are the platforms that are linked to iChoresDrone, enabling users to shop online and have their orders autonomously fulfilled by the UAV/UAS/Drone. Similar to retail vendors, these platforms provide product information, availability, and order details to the iChoresDrone system. In one embodiment, user's personalized device 110 is a special purpose computing device (such as mobile device) configured with application 115 which has biometric user identity logic. In one or more embodiments, Biometric Manager 210 comprises of fingerprint coordinate generator, retinal coordinate generator, facial coordinate generator, and biometric private key generator modules that are special purpose computing device (such as mobile device 110) configured with biometric user identity logic.

In an embodiment, the user's personalized device 110 is one or more digital devices. The term “digital device” generally refers to any hardware device that includes a processor. A digital device may refer to a physical device executing an application or a virtual machine. Examples of digital devices include a computer, a smart assistant, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

The user initiates a shopping request through the Application 115 on their device 110. This request is sent via the Network 120 to the Server 160 for processing. The Server 160 processes the order and determines the appropriate vendor(s) (either a retail or e-commerce vendor) for fulfillment. The server then communicates with the chosen Retail Vendor 140-1 . . . 140-N or E-commerce Vendor 150-1 . . . 150-N to place the order and arrange pickup. Once the order is confirmed, the Personalized Autonomous UAV/UAS/Drone 130 is instructed to navigate to the vendor's location to collect the item. The UAV/UAS/Drone uses real-time data from the network to optimize its route and ensure efficient delivery. The UAV/UAS/Drone 130 autonomously picks up the product and follows the optimized route to the user's location for delivery. The network continually provides real-time updates to the user through the application 115, including tracking information and estimated delivery time.

No action or function described or claimed herein is performed by the human mind. An interpretation that any action or function can be performed in the human mind is inconsistent with and contrary to this disclosure.

### Example Environment

FIG. 1 illustrates one embodiment of a computing system 100 associated with facilitating automated shopping and delivery via a personalized autonomous UAV/UAS/Drone, with integrated biometric verification for secure user authentication. This system is designed to operate within a networked environment, connecting users, backend servers, and a variety of retail and e-commerce vendors. In one or more embodiments, System 100 streamlines the end-to-end flow of request handling, transaction management, and delivery, providing an advanced, user-friendly shopping experience with minimal human intervention.

At the heart of System 100 is the User's Personalized Device 110, which serves as the primary interface through which users interact with the iChoresDrone platform. This device, typically a smartphone, tablet, or wearable device, is configured to support personalized authentication and security features to ensure a tailored and secure experience for each individual user. Within this personalized device, users access the application 115, a dedicated application that acts as the main access point for all services offered by the iChoresDrone platform. This application 115 provides users with an intuitive graphical interface to facilitate product browsing, order placement, real-time tracking of deliveries, and customizable notifications. Users can use the Mobile Application 115 to search for products across connected retail and e-commerce platforms, manage their shopping cart, and complete payments securely.

The application 115 communicates with the backend infrastructure over a centralized Network 120, which acts as the backbone of System 100, allowing seamless data transfer among all components, including the personalized user device 110, backend server 160, retail 140-1, 140-N and e-commerce vendors 150-1, 150-N, and the personalized autonomous UAV 130. Through the network 120, user requests generated by the application 115 are transmitted to the Server 160, which serves as the core processing unit of the system. The server 160 is responsible for managing backend operations and coordinating the flow of information between users, vendors, and the UAV 130. It is configured to handle multiple types of tasks, including request validation, order processing, vendor coordination, and routing optimization for the UAV 130.

Once a user initiates an order, the server 160 receives the request and validates it by checking for product availability, user authorization, and logistical feasibility. After successful validation, the server 160 places the order with the appropriate vendor—either a physical retail store or an online e-commerce platform—and initiates coordination with the vendor for order fulfillment. The system supports a variety of vendor types, represented as Retail Vendors 140-1 to 140-N and E-commerce Vendors 150-1 to 150-N, which enable a broad range of shopping options. The network facilitates secure and low-latency communication with these vendors, allowing the server to manage inventory queries, reservation details, and pickup schedules seamlessly.

Once the order is confirmed and the item(s) are prepared for pickup, the server dispatches the Personalized Autonomous UAV/UAS/Drone 130, a drone equipped with advanced autonomous navigation capabilities. This UAV/UAS/Drone 130 is designed to operate with minimal human intervention, using GPS and other positioning technologies to achieve precise location tracking and efficient navigation. The server communicates directly with the UAV/UAS/Drone 130 via the network 120, providing it with real-time instructions for routing and obstacle avoidance. Additionally, the UAV/UAS/Drone 130 is equipped with various sensors and algorithms to dynamically adjust its route and avoid obstacles, ensuring a safe and efficient journey to the vendor's location.

Upon arrival at the designated vendor location, the UAV/UAS/Drone 130 engages in an automated process for product collection. This is made possible through integration with the vendor's system, allowing the UAV/UAS/Drone 130 to verify and retrieve the correct order autonomously. The design of System 100 allows for flexibility in handling various vendor-specific protocols, ensuring compatibility and minimizing the risk of order fulfillment errors. Once the order is securely loaded, the UAV/UAS/Drone 130 departs for the user's delivery location, guided by optimized routing and obstacle detection capabilities.

Throughout the UAV's journey, the network 120 provides real-time data transfer to the user's mobile application 115, enabling the user to monitor the status and location of the delivery in real time. Notifications are pushed to the app to keep the user informed of any relevant updates, such as estimated arrival times and potential delays due to traffic or weather conditions. The user is able to track the UAV's progress as it approaches the delivery location, enhancing the transparency and reliability of the service.

Upon reaching the user's location, the UAV/UAS/Drone 130 completes the delivery autonomously, marking the order as fulfilled within the system. The server finalizes the transaction, updating the user's order history and processing payment if necessary. This autonomous delivery framework, powered by System 100, exemplifies a high level of integration, scalability, and user-centric design, streamlining the entire shopping experience from product browsing to doorstep delivery.

In one or more embodiments, System 100 provides a comprehensive, automated framework for modern e-commerce, leveraging advanced UAV technology, secure network communication, and backend processing to enable an efficient, user-friendly shopping and delivery experience. This architecture offers a seamless flow from user interaction to product delivery, setting a new standard in retail and e-commerce fulfillment by integrating personalized devices, autonomous drones, and a robust backend system that supports both retail and e-commerce vendor interactions. Through this intelligent system, iChoresDrone represents a significant step forward in automated service delivery, enhancing convenience, efficiency, and satisfaction for the modern consumer. Biometric authentication for secure, personalized control: By incorporating biometric authentication for both app access and drone control, the system offers a higher level of security and user control, which is not a feature in existing drone delivery solutions.

### Exemplary Principal Parts or Functions of the Present Invention

This block diagram highlights the interconnected modules that power the present invention (i.e., iChoresDrone). From user-facing elements in the GUI Module (such as order processing and tracking) to User Interaction capabilities (like navigation, obstacle detection, and safety measures), and backend management within the UAV Integration Management Module (handling vendor integration, API, and payment management), this system creates a seamless experience for autonomous drone-based e-commerce.

### Mobile Interface

In one embodiment of the present invention provides an application 115 that contains GUI 200 is the graphical user interface on the mobile app allows users to interact with the drone delivery system through a user-friendly dashboard. The mobile GUI enables quick access to critical features such as order tracking, delivery customization, and biometric authentication. It is designed for easy navigation on mobile devices, providing users with on-the-go control over their deliveries. Server Integration 202, the mobile app communicates with central servers to fetch real-time data, including order status, inventory updates, and user preferences. This integration ensures that the mobile interface always displays the latest information and allows seamless interaction with the overall system. Order Processing Manager 204, This feature on the mobile app enables users to place, modify, and cancel orders. It provides an intuitive order form, allows payment processing, and helps users track their orders from the moment they're placed to when they're dispatched for delivery. Order History and Recommendation 206, The mobile app stores the user's order history and analyzes it to provide personalized recommendations. For example, it may suggest frequently ordered items or offer discounts on favorite products, enhancing the user experience. Customizable Delivery Options 208 Through this feature, users can set specific delivery preferences directly from the app, such as scheduling a preferred delivery time, setting delivery notes, or choosing contactless delivery. These customizable options enhance convenience and flexibility for the end user. Biometric Manager 210, The mobile app supports various biometric authentication methods, including fingerprint, retinal, and facial recognition, depending on the capabilities of the user's device. It also allows for the generation of a biometric private key, providing an additional layer of security for accessing the app and authorizing drone deliveries. Retail Vendors Integration 212, This feature allows the mobile app to connect with retail vendors'systems, enabling users to browse available items from different stores, check stock, and place orders. It also supports direct integration for retail partners, making it easier for users to access a wider range of products. Ecommerce Vendors Integration 214, similar to retail integration, this feature connects the mobile app with ecommerce vendors, allowing users to browse products, check availability, and make purchases from ecommerce platforms within the app. Inventory Management Integration 216, This integration allows the mobile app to display up-to-date stock information, so users can see real-time availability for items across different vendors. It ensures that customers do not place orders for out-of-stock items, enhancing the ordering experience. Personalized Autonomous UAV Integration Manager 218 This module on the mobile app coordinates interactions with UAVs based on user-specific settings and preferences. It allows users to monitor their assigned UAV's status, view estimated arrival times, and make real-time adjustments if needed. It ensures the delivery experience is tailored to the user's preferences.

### User Interaction Manager to Multi-order Payload Delivery Module

In another embodiment of the core functionalities of the present invention that manage user's personalized autonomous UAV/Drone 130 operations, security, and delivery logistics. User Interaction Manager 220 manages how the mobile app communicates with the UAV system, including the authentication of users via fingerprint, retinal, facial, and voice recognition. It coordinates commands from the mobile app to the UAVs, ensuring the user's instructions are carried out precisely. The User Interaction Manager 220 is a critical module within the autonomous drone system that handles all aspects of user authentication and interaction. It ensures secure access to drone functionalities and manages the seamless execution of delivery operations by verifying user identities through multiple biometric and voice recognition methods. This multi-faceted approach enhances security, user convenience, and system reliability. The User Interaction Manager is a sophisticated module that integrates multiple biometric and voice recognition technologies to ensure secure, reliable, and user-friendly authentication within the autonomous drone delivery system. By leveraging Fingerprint Coordinate, Retinal Coordinate, Facial Coordinate Generator, Biometric Private Key Generator, and Voice Recognition, the system provides robust multi-factor authentication mechanisms for:

Registering Users: Capturing and securely storing comprehensive biometric data.

Validating Access: Ensuring that only authenticated users can control and interact with the drone.

Verifying Deliveries: Confirming recipient identities to secure package handovers.

This multi-layered approach not only enhances security but also streamlines user interactions, making the autonomous drone delivery system both safe and convenient for all stakeholders involved.

Components of User Interaction Manager 220
Fingerprint Coordinate
Retinal Coordinate
Facial Coordinate Generator
Biometric Private Key Generator
Voice Recognition

Each of these components plays a specific role in the authentication lifecycle: Registration, Validation, and Verification.

### Fingerprint Coordinate

Fingerprint Coordinate refers to the precise mapping and recognition of a user's fingerprint patterns. Utilizes high-resolution fingerprint sensors to capture unique ridge patterns, minutiae points, and other distinguishing features.

During the initial setup, the system prompts the user to place their finger on the fingerprint scanner. The fingerprint coordinate generator captures a unique digital map of the user's fingerprint ridges and valleys, generating a secure, encrypted fingerprint template. This template is stored securely within the system as a reference for future authentication. When the user interacts with the system later (for instance, to retrieve a delivery), they are prompted to scan their fingerprint again. The system compares the live scan with the stored fingerprint template. This comparison uses sophisticated pattern-matching algorithms to ensure accuracy and security. Fingerprint recognition is one of the quickest methods of biometric authentication. The fingerprint coordinate module is typically used for quick validations when a user needs fast access, such as unlocking the app or confirming a delivery upon drone arrival. During sensitive operations (e.g., package pickup), additional fingerprint scans ensure ongoing verification. Each fingerprint validation event is logged for audit purposes, enhancing traceability and accountability.

### Retinal Coordinate

Retinal Coordinate involves the use of retinal scanning technology to capture the unique patterns of blood vessels in the retina. Provides one of the most secure forms of biometric authentication due to the complexity and uniqueness of retinal patterns. To register retinal data, the system uses a high-resolution camera to scan the user's eye and capture unique patterns of the retina's blood vessels. The retinal coordinate generator then creates a digital map of these unique vascular patterns, which are stored securely for later comparison. When accessing the UAV delivery service, the user may be required to scan their retina. This live scan is then compared to the stored retinal template to authenticate the user's identity. Users undergo a retinal scan using specialized retinal scanners integrated into the mobile device or drone interface. High-resolution images of the retina are captured, focusing on the intricate vascular patterns. Retinal data is encrypted and securely stored within the user's biometric profile.

Retinal scans are extremely accurate and highly secure, making them suitable for sensitive actions, such as confirming high-value deliveries or accessing restricted zones in the UAV system. Due to the complexity of retinal scans, they may be used in combination with other biometrics for multi-factor authentication (MFA). Users present their eyes to the retinal scanner when accessing drone functionalities. The system matches the live retinal scan against the stored retinal coordinates to confirm identity. Successful validation grants access to sensitive drone operations, ensuring only authorized users can perform critical tasks. Retinal scans can act as a secondary verification method, especially in high-security scenarios. Retinal verification can be periodically required during prolonged interactions to maintain security integrity.

### Facial Coordinate Generator

The Facial Coordinate Generator employs advanced facial recognition algorithms to create a comprehensive map of a user's facial features. Utilizes 3D imaging and deep learning techniques to enhance accuracy and resistance to spoofing attempts. The system guides the user to position their face in front of a camera during the registration phase. Using facial recognition technology, the facial coordinate generator captures unique features of the user's face, such as the distance between the eyes, nose shape, and jawline structure. Users capture their facial data through the mobile app's front-facing camera. The facial coordinate generator creates a detailed 3D map of facial landmarks, including the distance between eyes, nose shape, cheek contours, and jawline. This information is stored as an encrypted template. Encrypted facial data is stored in the biometric database, associated with the user's profile.

For future interactions, the user's face is scanned, and the live facial coordinates are compared to the registered template. The system checks multiple facial landmarks for precise matching. Users position their face within the camera's view during login or drone interaction initiation. The system compares the live facial data against the stored facial coordinates to validate the user's identity. Upon successful facial recognition, the user is granted access to the drone's features and delivery functionalities. Facial recognition is user-friendly and ideal for quick verification. In this system, it could be used when the user is interacting with a mobile app or when a drone is delivering items that require visual identification of the recipient. This is especially effective for contactless deliveries where the drone's onboard camera can verify the recipient's identity. Continuous facial recognition can monitor the user's presence and ensure the authenticated user remains engaged during operations. If facial recognition fails at any point, the system can trigger alerts or lock access to prevent unauthorized usage.

### biometric Private Key Generator

The Biometric Private Key Generator creates unique cryptographic keys based on the user's biometric data. Ensures that each user's biometric data is transformed into a secure, non-reversible cryptographic key used for authentication purposes.

When a user registers multiple biometric identifiers (such as fingerprint, retinal, and facial data), a biometric private key is generated by combining these biometric features into a single encrypted key. This private key is unique to each user and acts as a secure digital identifier. During enrollment, the biometric private key generator processes the captured biometric data (fingerprint, retinal, facial) to generate a unique private key. The generated private key is stored securely within the user's profile, often within a secure element of the mobile device or a protected server environment. The private key is linked to the user's biometric data to ensure that authentication requests can be cryptographically validated.

For critical actions (like accessing sensitive data or modifying user settings), the system can require the biometric private key. This ensures a higher security level, as the key is generated only by combining the user's biometrics in a unique pattern. When a user attempts to authenticate, their biometric data is used to regenerate the private key, which is then compared against the stored key. The system uses cryptographic techniques to verify that the generated key matches the stored key without exposing the actual biometric data. Successful key verification allows the user to access the drone's functionalities securely. The biometric private key serves as a form of multi-factor authentication (MFA). For instance, if a user attempts to change account settings or initiate a delivery override, the system can require the biometric private key. This prevents unauthorized access, as only the registered user can generate this unique key with their biometric data. The biometric private key adds an extra layer of security by ensuring that even if biometric data is compromised, the private key remains secure. Since private keys are derived from biometric data, they are unique to each user and cannot be easily replicated or forged.

### Voice Recognition

Voice Recognition utilizes the user's unique vocal characteristics to authenticate and authorize actions within the drone system. Incorporates natural language processing and machine learning to accurately identify and verify users based on their voice patterns.

The user is prompted to speak specific phrases or sentences to register their voice pattern. Users record their voice through the mobile app, speaking predefined phrases or commands. The system analyzes unique vocal attributes, such as tone, pitch, and speaking speed, creating a voice template that is securely stored. Encrypted voiceprints are stored in the biometric database, linked to the user's profile.

When the user attempts to perform certain actions, the system may prompt them to repeat a particular phrase. Users speak to the mobile app or drone interface when initiating access or commands. The live voice sample is then compared with the stored template to confirm the user's identity. The system compares the live voice input against the stored voiceprint to validate the user's identity. Upon successful voice recognition, the system authorizes the user's commands, enabling actions such as starting a delivery or accessing sensitive settings.

Voice recognition is especially useful for hands-free interaction. For instance, if the user is in a situation where they cannot physically interact with the device (e.g., their hands are full), they can use voice commands to authorize actions like unlocking the app, confirming receipt of a delivery, or requesting a delay in delivery timing. Voice recognition can be used throughout interactions to ensure the ongoing presence and identity of the user. The system can detect unusual voice patterns or unauthorized attempts, triggering security protocols if discrepancies are found.

### Process Workflow: Registration, Validation, and Verification

### User Registration Process

Initiate Registration: The user begins the registration process through the mobile app or a personalized autonomous drone component 370, which triggers the User Interaction Manager.

Capture Biometric Data: The system sequentially prompts the user to provide fingerprint, retinal, facial, and voice data. Each data point is processed by its respective coordinate generator (fingerprint, retinal, facial) and stored securely in the system.

Generate Biometric Private Key: After gathering all biometric inputs, the User Interaction Manager combines these inputs to create a unique biometric private key for the user.

Complete Registration: Once the biometric data and private key are registered, the user profile is marked as authenticated, and the user is granted access to the UAV delivery system with their multi-layered biometric identity.

### User Validation Process

Authentication Request: When the user accesses the app or attempts to perform a high-security action (like confirming delivery), the User Interaction Manager initiates validation.

Biometric Matching: The system requests one or more biometric inputs (e.g., fingerprint, retina scan, or face recognition) and compares them with the stored templates.

Biometric Private Key Check (for Sensitive Actions): If the action is highly sensitive, the system may require the biometric private key, combining multiple biometrics. This additional layer ensures only the registered user can complete the process.

Validation Success: If the biometric data matches, the action is authorized, and the user can proceed.

### User Verification During Delivery

Delivery Confirmation Prompt: Upon UAV arrival, the system prompts the user to confirm receipt. The drone, through onboard biometric sensors, may request a live fingerprint scan, facial recognition, or even voice command for hands-free verification.

Biometric Verification: The drone's sensors or the app will capture the necessary biometric data and compare it with the stored templates in real-time.

Multi-factor Confirmation (if required): For high-value items, the system may prompt the user to provide multiple forms of biometric data (e.g., facial recognition plus fingerprint or retinal scan) to ensure the correct recipient is present.

Delivery Completion: Once the verification succeeds, the UAV completes the delivery, and the transaction is recorded in the system.

All biometric data and generated private keys are encrypted both in transit and at rest to prevent unauthorized access and data breaches. Biometric data is stored in secure, tamper-proof environments, such as hardware security modules (HSMs) or encrypted cloud storage with strict access controls. Implement liveness detection in biometric scanners to prevent spoofing attacks using fake fingerprints, retinal images, or facial masks. Use advanced algorithms to differentiate between real and artificial biometric inputs. Conduct regular security audits to ensure the integrity of biometric systems. Monitor authentication logs for suspicious activities and implement real-time alerting mechanisms. Obtain explicit user consent for collecting and using biometric data. Provide users with control over their biometric information, including options to update, delete, or manage their biometric profiles. Adhere to global data protection regulations such as GDPR, CCPA, and others to ensure legal compliance and protect user privacy.

Retail/Ecommerce Vendor Integration 222 This module allows seamless integration between the UAV delivery system and both retail and ecommerce vendors, enabling a smooth flow of information and orders between vendors and the delivery network. Autonomous Navigation 224 Handles autonomous flight capabilities for UAVs, allowing them to navigate independently to delivery destinations. It includes navigation algorithms that optimize routes and avoid obstacles, ensuring safe and efficient travel. Dynamic Routing Capabilities 226 This feature dynamically adjusts routes in response to real-time conditions, such as weather or traffic updates, to improve delivery efficiency and reliability. Delivery Routing Optimization Algorithms 228, These algorithms optimize delivery routes to minimize time, distance, and resource use. They analyze factors like package weight, distance, and priority to generate the best possible routes for UAVs. Obstacle Detection and Avoidance 230, This system uses sensors and AI to detect and avoid obstacles during UAV operation, reducing the risk of collisions and enhancing safety. Geofencing Capabilities 232, The UAV system enforces geofencing, restricting UAVs to predefined zones and preventing them from entering restricted areas. This is essential for regulatory compliance and ensures UAVs operate within authorized boundaries. Safety and Compliance (Regulatory, Emergency Protocol, Weather Resilience) 234, This module ensures the UAVs adhere to legal and safety regulations. It includes emergency protocols and weather resilience measures, allowing the UAVs to handle various environmental conditions safely. Multi-order Payload Delivery Module 236 This feature enables UAVs to carry multiple orders simultaneously, optimizing delivery capacity and efficiency. The module manages payload balance and secures multiple packages, allowing for efficient multi-order deliveries.

### UAV Integration Management to Payment Management

In one embodiment illustrates how retail, ecommerce vendors, suppliers are interacting. UAV Integration Management 238 Manages each UAV's integration into the fleet, coordinating its operations within the delivery network. It ensures that UAVs operate in sync with each other and follow assigned tasks without conflict. Ecommerce Integration Management 240 Manages integration with ecommerce platforms, facilitating direct access to orders, inventory, and tracking. This enables smooth cooperation between the UAV delivery system and ecommerce partners, enhancing order fulfillment. Order Management 242 Overseeing the complete lifecycle of orders, this module tracks each stage from creation to completion. It provides updates to both vendors and customers, ensuring transparency and reliability in the order process. Delivery Management: 244 Focuses on coordinating each delivery task, ensuring that packages are routed accurately and delivered on time. It manages UAV assignment, route planning, and delivery notifications for customers. API Management 246 Provides a set of APIs that allow integration with external systems, such as vendor platforms, inventory management systems, and payment gateways. This enables data sharing and seamless interoperability with other systems. Retail Vendor Management 248 Manages interactions with retail partners, overseeing inventory updates, order placements, and coordination of deliveries. It ensures that retail vendors have a streamlined process for working within the UAV delivery system Product Catalog Management 250 Allows vendors to update their product listings within the UAV system. It enables adding, updating, and removing items in the catalog, ensuring that available products are accurately displayed to customers. Order Management 252 manages complete order details from UAV. Payment Management 254 handles payment processing, integrating with payment gateways for secure transactions. It manages payment status, invoicing, and potential refunds, ensuring a smooth transaction experience for users and vendors.

### Exemplary User's Personalized Autonomous UAV Device/Drone

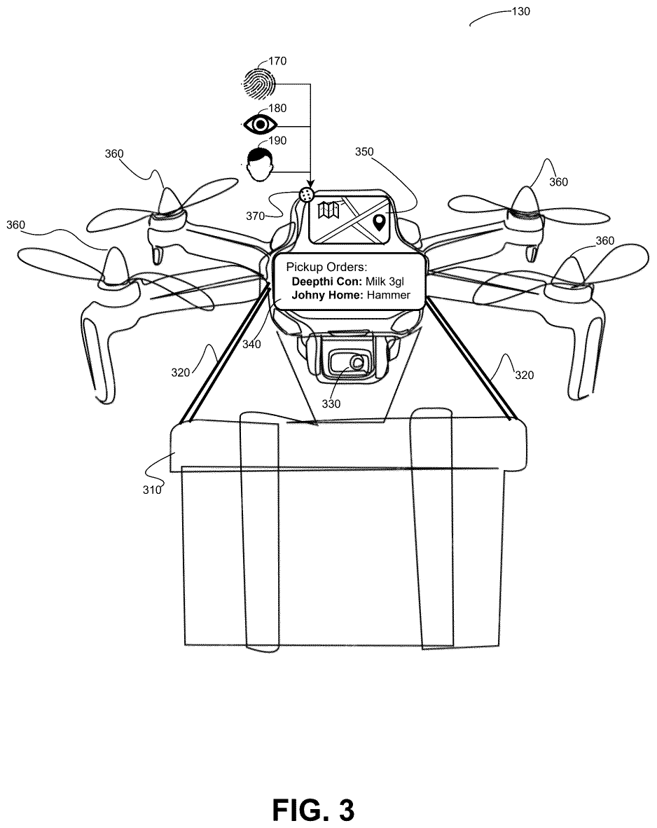

FIG. 3. illustrates an exemplary embodiment of user's personalized autonomous Drone (unmanned aerial vehicle (UAV), or unmanned aircraft system (UAS)) of the present invention, showcasing of personalized autonomous drone components and the core functionality of the system. Fingerprint Icon 170 Represents the fingerprint authentication sensor. This sensor allows the drone to verify the identity of the authorized user through their fingerprint, adding a layer of biometric security. Only authenticated users can initiate or interact with the drone, enhancing security for package deliveries. Eye Icon 180 Likely represents a visual recognition or facial recognition system. This sensor may scan the user's face to verify identity, adding an additional biometric check. Alternatively, it could enable gaze detection or visual feedback, helping the drone to identify or monitor its surroundings for enhanced navigation. Person/Face Icon 190 represents the facial authentication system. The system uses facial recognition to verify the identity of the user, providing an additional biometric security layer. This allows only authorized individuals to access or operate the drone, ensuring secure delivery handling. Package Compartment 310 is where items for delivery are placed. This compartment is securely attached to the underside of the drone and is designed to carry different payloads safely. It may include security features to prevent unauthorized access, such as a lock or tamper-proof mechanism, and might also have sensors to check weight or volume.

Suspension System 320 Part of the suspension mechanism that secures the package compartment to the main body of the drone. This system reduces vibrations and stabilizes the payload during flight, ensuring that the package remains steady. This is especially important when carrying fragile or sensitive items. Camera Module 330 is used for visual navigation, obstacle detection, and real-time feedback on the delivery status. It could also perform visual recognition of landmarks to help the drone navigate autonomously. This camera might also serve as a security feature to document deliveries and verify the recipient or drop-off location. Display Screen 340 is the LCD screen that shows a list of pickup orders or deliveries assigned to the drone. For instance, it may list details such as “Deepthi Con: Milk 3 gl” and “Johny Home: Hammer,” allowing users to confirm items before initiating delivery. This screen helps ensure that each delivery task is clear and organized. Navigation Screen 350 that displays the route, map, or GPS details necessary for the drone to follow its path. It provides real-time navigation information, allowing the operator to monitor the drone's location, planned route, and delivery stops. This screen may be used to ensure the drone stays on course or to troubleshoot navigation issues. The propellers 360 generate lift and thrust, allowing the drone to take off, hover, and maneuver. Each propeller has an individual motor that enables precise control over the drone's movement by adjusting the speed and angle of rotation. The propellers work together to maintain stability during flight and allow the drone to navigate efficiently through various environments.

Biometric Sensor 370 enables secure input of biometric data, such as fingerprints or possibly other biometric metrics, for user authentication. This sensor provides an additional security measure by allowing only authorized users to access or operate the drone, ensuring secure package handling throughout the delivery process. This sensor is a key component for biometric security, allowing secure input of various biometric data, such as fingerprints or possibly other biometric metrics. It authenticates users before granting access to the drone's functions or packages, ensuring that only verified individuals can handle deliveries. With both facial authentication 190, Retinal Scan 180 and fingerprint authentication 170 are the user's biometric co-ordinates that in place, the drone achieves multi-factor biometric security. The user must pass both fingerprint and facial recognition checks to access the drone. This dual authentication increases security, ensuring that only fully verified users can control the drone or access its contents. At each delivery point, the drone verifies the recipient's identity using Retinal Scan 180, facial authentication 190 and/or fingerprint verification 170. Only once the correct recipient is authenticated will the package compartment 310 unlock, ensuring secure and precise handover of deliveries. By integrating Retinal, facial and fingerprint authentication, the drone provides a comprehensive security solution, allowing only verified individuals to access and operate the system at each stage of the delivery process. This ensures that packages reach their intended recipients securely.

The biometric sensor 370 plays a central role in the secure operation and access control of the autonomous delivery drone. It enhances security by ensuring that only authorized users can access the drone's functions, initiate delivery operations, and retrieve packages. The biometric sensor 370 acts as a primary authentication point for the drone. When a user (such as a delivery person or an authorized recipient) approaches the drone, they can authenticate themselves by scanning their fingerprint or other biometric data (such as facial recognition or iris scan, if supported). This sensor can work alongside other identifiers, such as a visual recognition system 180 and fingerprint sensor 170, to provide multi-factor authentication (MFA). This multi-layered security approach ensures that only verified individuals can interact with the drone, reducing the risk of unauthorized access. Depending on the user's profile (e.g., a delivery driver vs. a recipient), the biometric sensor can grant different levels of access. For example, a delivery driver may have full operational control, while a recipient might only have permission to open the package compartment. Before picking up packages, the authorized user, typically a delivery operator, must authenticate via the biometric sensor. Once authenticated, the drone allows access to the list of assigned deliveries on the display screen 340. This prevents unauthorized users from tampering with the package list or rerouting the drone. After successful authentication, the drone could record the user's biometric data as proof of pickup. This data serves as a log, documenting who accessed the drone and when. This is particularly useful for audit trails and can prevent package loss or theft by verifying who interacted with the drone at each stage.

For secure delivery, the drone can be configured to verify the recipient's identity using the biometric sensor. When the drone reaches the delivery location, the recipient can authenticate themselves via the biometric sensor to confirm their identity. This ensures that packages are only handed over to the intended recipient, reducing the chances of delivery errors. If the drone delivers multiple packages in a single trip, the sensor can verify each recipient at each delivery point, cross-checking them with the delivery list displayed on the screen 340. Only when the correct recipient is verified does the drone unlock the package compartment, ensuring precise and secure package handover. The biometric data of the recipient can also serve as proof of delivery. This can be logged in the drone's system or transmitted to the delivery management platform, offering evidence that the package was received by the authorized individual. The package compartment 310 is locked and can only be accessed after successful biometric verification. This feature is especially useful in high-risk environments or for delivering sensitive or high-value items, as unauthorized individuals cannot easily tamper with or remove packages. In case the drone cannot authenticate the intended recipient at a delivery location, it can be programmed to return to a designated safe location or central hub. The biometric sensor helps enforce this policy, ensuring that packages are not left unattended or handed over without verification. Based on the environment and security requirements, the drone's settings can be adjusted to require multiple biometric inputs (e.g., both fingerprint and facial recognition) before allowing access. This is especially useful for critical deliveries, such as sensitive documents, medical supplies, or valuable goods. The biometric sensor provides a quick and convenient way for authorized users to access the drone and retrieve packages without needing PIN codes or passwords. This minimizes human error and speeds up the process of package retrieval. The biometric data collected (e.g., fingerprints, facial recognition) is sensitive information. The drone could be designed to process and store this data securely, either encrypting it onboard or sending it to a secure, privacy-compliant cloud platform. This ensures compliance with privacy regulations like GDPR or CCPA, maintaining user trust.

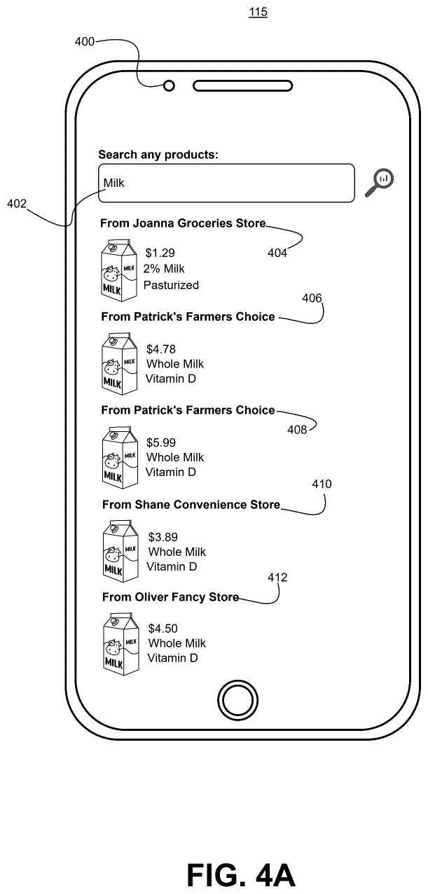

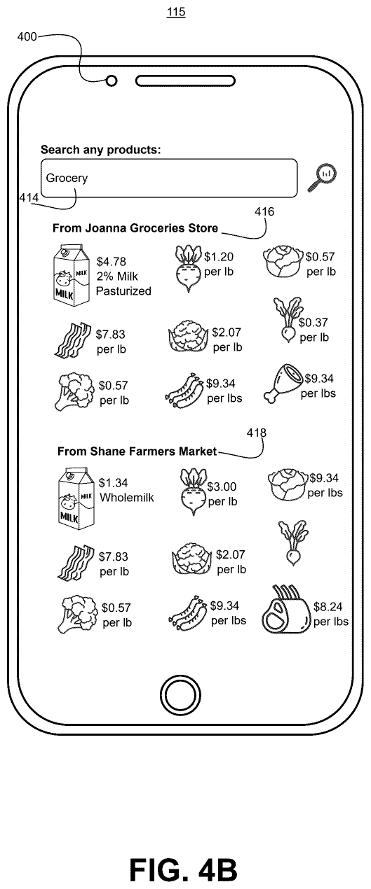

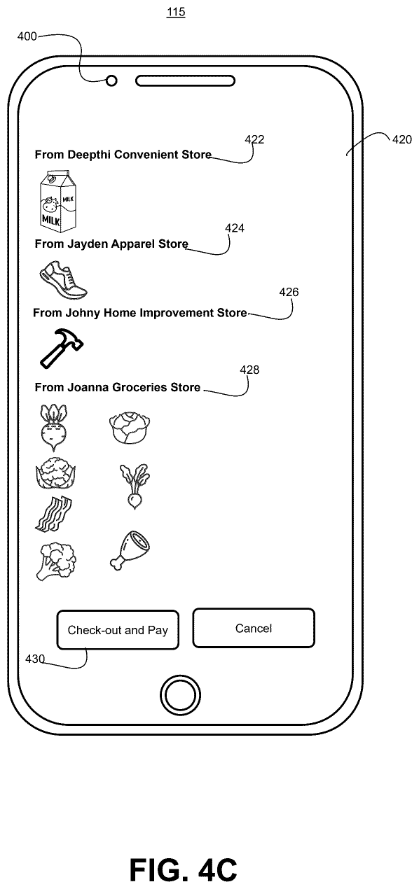

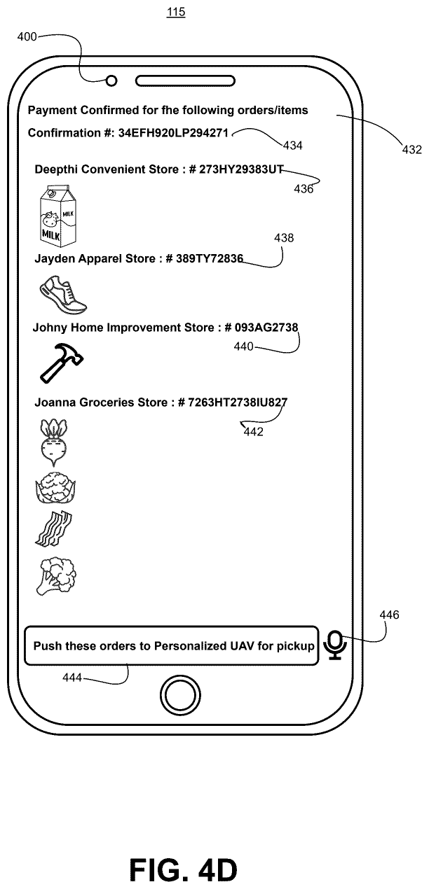

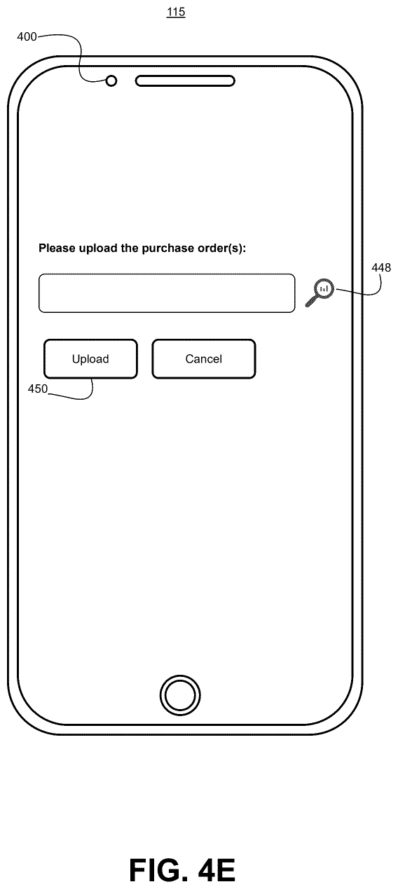

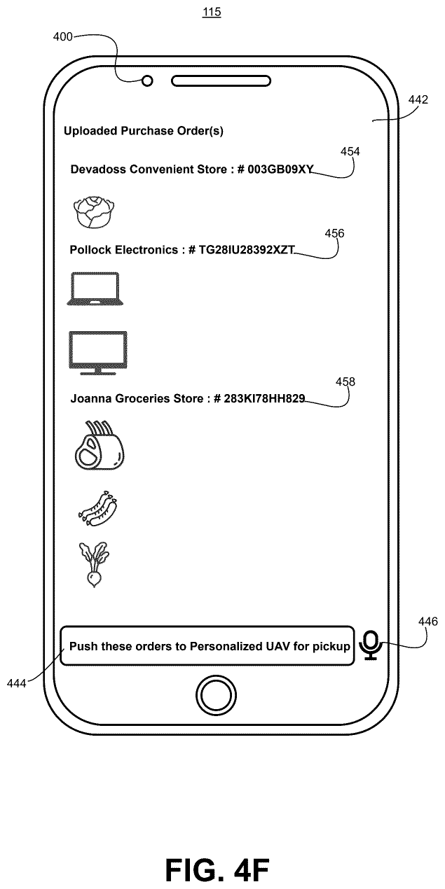

In one embodiment, component 370 enable the Voice Verification for Command Validation. Whenever the payment process is successfully completed, the system immediately generates a complete payment confirmation screen, labeled as 432 (such as shown in FIG. 4D). This confirmation page provides the user with a comprehensive summary of the entire transaction, including the total amount paid, the individual prices of each item, and a unique system confirmation number 434 (such as shown in FIG. 4D) for reference. This confirmation number serves as a record of the payment and acts as an identifier for the entire order, ensuring the user has all the necessary details for future inquiries or issues regarding their order. After the user submits their payment details, the system processes the transaction via a secure payment gateway. Once the payment is authorized, funds are transferred to the respective vendors, and the system generates the payment confirmation. This confirmation is then displayed to the user, along with a system confirmation number, which ties together the entire transaction and provides a reference for the order. As the system communicates with each vendor's system to process the individual orders, each vendor generates its own confirmation number for the products they are fulfilling. These confirmation numbers 436, 438, 440, and 442 (such as shown in FIG. 4D) in the example—serve as unique identifiers for each product ordered from the respective vendor. The system then retrieves and displays these confirmation numbers, ensuring the user can verify the order details from each vendor individually. This step ensures that both the user and the system have accurate, up-to-date information on the status of each item, including which vendor is processing the order and any potential issues related to inventory, pricing, or availability. In addition to the traditional button click for order confirmation, the system also integrates a voice verification mechanism for enhanced security and user interaction.

As shown in FIG. 3, the voice verification generator 370 plays a critical role in ensuring that the voice commands issued by the user are both accurate and authentic. When the user attempts to use a voice command, such as “Hey iChoresDrone, go collect the packages”, the system first uses the voice verification generator to record and analyze the user's voice. This step ensures that the system only responds to commands issued by the authorized user. The voice verification technology compares the user's spoken input against pre-recorded voice profiles stored in the system. If the voice command matches the authorized voice print, the system proceeds with processing the request. If there is a mismatch or the voice is unrecognized, the system will not respond, ensuring that only the correct user can initiate commands for the drone. For example, if the user says “Hey iChoresDrone, go collect the packages,” the system first checks that this voice input matches the stored voice profile of the user. Only after successful verification does the system recognize the command and initiate the UAV's collection process. This process adds a layer of security, preventing unauthorized users from interacting with the system and ensuring that voice commands are always coming from the rightful user. After the payment and confirmation details have been reviewed by the user, they are presented with the option to initiate the pickup process. This can be done in two ways: The user can click the “Push these orders to Personalized UAV for pickup” button 444 (such as shown in FIGS. 4A-F), which triggers the system to send the details to the personalized autonomous UAV (drone) 130 to begin the item collection process. This option is straightforward and does not require voice interaction, making it an efficient alternative for users who prefer not to use voice commands. Alternatively, the user can issue a voice command by saying, “Hey iChoresDrone, go collect the packages.” This command is detected when the user presses the microphone icon 446 (such as shown in FIG. 4D) in the app 115, activating the voice recognition system. However, before the system responds, it first ensures that the voice input is valid by matching it against the user's pre-recorded voice profile using the voice verification generator 370. Once the voice is authenticated, the system proceeds to process the command and directs the UAV to collect the items from the various vendors. Once the command is verified and accepted, the system provides the UAV with all necessary details, such as the items to be collected, vendor locations, and any specific instructions for the pickup. The UAV then proceeds to collect the items autonomously, following the optimal path calculated based on real-time data. The UAV's flight path is carefully optimized to ensure efficiency and minimize delays during the collection process.

In one or more embodiments, the system's process works in multiple stages: After the payment is successfully processed, the system displays a detailed payment confirmation with both a system-wide confirmation number and vendor-specific confirmation numbers. The voice verification generator 370 ensures that only the authorized user's voice is recognized and validated before responding to any voice command, enhancing both security and user control. Once the user verifies their order details, they can initiate the collection process by either pressing a button or issuing a verified voice command. This dual approach to user interaction ensures that the system is both secure and responsive, offering a seamless experience from payment to order fulfillment.

In one or more embodiments, the present invention leverages the Biometric Security During a Typical Operation such as Pickup Authorization, In-Transit Security, Delivery Verification, Return Protocol (If Recipient Not Verified). In one embodiment, the delivery operator authenticates via the biometric sensor 370. Once authenticated, the drone displays the assigned deliveries and allows the operator to begin the route. The drone records this interaction, logging the operator's biometric data as proof of access. In another embodiment, during flight, the drone remains locked, with the package compartment 310 inaccessible until the drone arrives at the correct delivery location and verifies the recipient. In another embodiment, tt the delivery location, the intended recipient verifies their identity through the biometric sensor. If the recipient is successfully authenticated, the package compartment unlocks, allowing access to the intended package. The drone logs the biometric verification as proof of delivery, updating its records or notifying the central system. In another embodiment, If the recipient's biometric data doesn't match, the drone can either prompt for an additional verification method or return the package to a designated safe location. This ensures that undelivered packages remain secure and are not left unattended.

In one or more embodiment, the personalized autonomous drone 130 is optimized for secure and efficient package delivery, with several advanced features enabling a seamless, user-friendly delivery experience. In one embodiment, provides Multi-Layered Biometric Security by equipping with user's biometric coordinates 170, 180, 190 and biometric sensors 370, the drone ensures that only authenticated and verified users can operate or interact with it. This multi-layered biometric authentication protects the drone and its payload from unauthorized access.

The main display screen 340 provides a clear list of delivery items, making it easy to track multiple orders and ensuring the operator is aware of each package's details before commencing delivery. This helps prevent confusion and enhances delivery accuracy. The navigation screen 350 shows route details, GPS coordinates, and map data, enabling precise route tracking and navigation. This feature supports autonomous navigation by providing critical location data, making the drone well-suited for multi-stop delivery routes or complex urban environments. The suspension system 320 helps keep the package stable during flight, preventing movement or vibrations that could compromise delicate items or affect the drone's balance. This stability enhances the drone's performance, especially over longer distances or in windy conditions. The camera module 330 enables visual recognition and monitoring, supporting autonomous navigation and real-time feedback for obstacle avoidance. The camera can also document delivery confirmation by capturing images at drop-off points, providing visual evidence of delivery completion. The propellers 360 are designed to provide optimal lift, stability, and control. Their configuration allows the drone to handle various payload weights while maximizing battery life and ensuring smooth, balanced flight.

In one or more embodiments the personalized autonomous drone 130 combines biometric security, real-time navigation, and a user-friendly interface for managing multiple deliveries. These features make it highly suitable for secure, autonomous delivery operations, particularly in urban settings where efficient navigation and security are critical.

### Exemplary Embodiments

FIG. 4A illustrates an exemplary embodiment of the present invention, showcasing the system's ability to facilitate product searches and display relevant results for the user. FIG. 4A represents the core functionality of the system, allowing the user to search for products, view real-time listings from various vendors, and compare prices efficiently. All of these operations occur seamlessly in the background, providing the user with a smooth, intuitive experience when searching for and purchasing products online. In one embodiment, the user initiates a search by typing “milk” 402 into the search bar, as shown in FIG. 4A. This simple action triggers a series of backend processes that enable the system to present the user with a range of milk products from multiple vendors.

When the user enters the search query, the system first sends the term “milk” to the central database, which is connected to a network of various vendor databases. These vendor databases may belong to retail stores, online marketplaces, or specific product suppliers. The system employs advanced search algorithms, including keyword matching and natural language processing techniques, to ensure that all relevant results—whether it be whole milk, skim milk, organic milk, or any other variation—are retrieved from the vendor databases.

Once the search query is processed, the system then aggregates the search results from each vendor. For each milk product, the system collects key details such as product name, description, pricing information, and availability status. The results are then ranked and organized by various factors, such as relevance, vendor rating, or price, depending on the user's preferences or the system's default settings.

As illustrated in the figure, the user is presented with a selection of milk products, each listed alongside essential information, including prices from different vendors. For example, the system may display prices such as $1.29 for vendor 404, $4.78 for vendor 406, $5.99 for vendor 408, $3.89 for vendor 410, and $4.50 for vendor 412. Each of these prices corresponds to the same or similar product but is sourced from different vendors, allowing the user to compare prices and make a more informed purchasing decision. The system queries multiple vendor databases or APIs to retrieve up-to-date product listings. This might include real-time stock availability and pricing, ensuring that the user is seeing accurate and current information. The system uses sophisticated algorithms to filter, sort, and prioritize the results. It takes into account user preferences, such as product type, brand, and even geographic location, ensuring that the search results are not only relevant but also convenient for the user. The system compares prices across vendors, displaying them in a clear format. It also checks for any discounts, promotions, or special offers that might apply, ensuring that the user is aware of potential savings. The aggregated data is then displayed in an easy-to-read format, showing the product details, prices, and vendor names, along with any relevant metadata (such as ratings or shipping times), enabling the user to compare options quickly.

FIG. 4B illustrates an exemplary embodiment of the present invention, demonstrating the system's capability to facilitate product searches and present a curated list of results for the user. In this particular scenario, the user initiates a search by typing the word “grocery” into the search bar, as shown in FIG. 4B. This seemingly simple input sets off a series of sophisticated processes in the background that enable the system to display a list of grocery items sourced from multiple vendors, complete with detailed pricing information for each product. In one embodiment, the present invention allows the user to search for grocery items, compare prices from different vendors, and view availability in real-time. The backend operations involve querying multiple databases, filtering and sorting results based on relevance and user preferences, retrieving live data such as pricing and availability, and presenting the information in an organized format. These operations happen seamlessly and almost instantaneously, providing the user with a smooth and efficient search experience. Once the user types the term “grocery” 414 into the search bar, the system immediately processes the input. This action sends the query to the backend, where it is parsed and analyzed using search algorithms that can interpret the user's intent. In one embodiment, the system recognizes that the user is interested in grocery items, and it begins searching for related products across various vendor databases and online marketplaces. The system sends requests to multiple external databases or APIs belonging to various grocery vendors. These may include both physical grocery stores with online ordering capabilities and e-commerce platforms specializing in groceries. The system uses these requests to pull a comprehensive list of grocery items that match the search term. This includes searching for general categories like “vegetables,” “fruits,” “canned goods,” “snacks,” and so on, depending on the range of products a particular vendor offers. Once the relevant product listings are retrieved, the system processes the data to eliminate irrelevant or duplicate items. The backend filters the results based on predefined criteria such as product category, vendor availability, and geographic location of the vendors. This ensures that only the most relevant grocery items are displayed to the user. The system may also use algorithms to sort the results by factors like price, customer ratings, or product popularity.

In FIG. 4B, the user is shown a list of grocery items, which are sourced from two different vendors, labeled 416 and 418. For each item, the system displays the product name, a brief description (if available), and the price from each vendor. The prices displayed may vary depending on vendor-specific promotions, geographic location, and stock availability. The system retrieves this pricing information directly from the vendors'databases or APIs. It ensures that the prices shown are up-to-date and accurate at the time of the search, incorporating real-time data such as discounts, special offers, or promotions that the vendors may be running. As part of the process, the system also checks the current availability of each product by querying the vendors'point-of-sale (PoS) systems or inventory management APIs. This step ensures that the products listed are in stock and available for purchase. If any item is out of stock, the system may display a message such as “Out of Stock” or “Currently Unavailable,” or it may offer an alternative product suggestion from another vendor. Once the system has aggregated the product listings, the results are displayed to the user in an intuitive and easy-to-navigate interface. The items are listed along with the vendor names, prices, and relevant product details, as shown in FIG. 4B. Each grocery item is listed with its respective price from vendors 416 and 418, allowing the user to compare the cost of similar products across different stores. After the user sees the list of available grocery items, they can click on individual items for more detailed information, such as product descriptions, nutritional details, and customer reviews. Additionally, the user may be able to filter the results further by selecting specific criteria such as price range, product type, or vendor. If the user decides to make a purchase, they can add the items to their virtual shopping cart, or if available, they can choose to buy directly from the displayed results. The system may also suggest related products based on the user's search history, preferences, or trending items.

In essence, FIG. 4C depicts the final step in the shopping experience, where the user's product selections from multiple vendors are displayed in a consolidated shopping cart. The system's backend works efficiently to aggregate and verify the items, check inventory, and ensure that the pricing and product details are accurate. Once the user verifies their selections, they can proceed to the checkout and payment process, where the system securely processes the payment and coordinates with the vendors to fulfill the order. This seamless integration of product selection, payment, and vendor coordination ensures a smooth and efficient shopping experience for the user. Once the user has carefully compared the products and prices from various vendors, and has selected their desired items, the system proceeds to display a comprehensive summary of the user's selections.

This is illustrated in FIG. 4C, where the present invention consolidates the user's chosen products from different vendors into a unified view, providing an organized shopping cart interface. After the user selects products from multiple vendors, the system aggregates these selections and organizes them into a shopping cart. The shopping cart displays a clear list of all the items the user has chosen, as shown in FIG. 4C. For each product, the system includes detailed information such as the product name, quantity, price, and the vendor from which the item was sourced. The items are listed alongside their respective vendors, labeled 422, 424, 426, and 428 in the figure, providing full transparency of where each product is coming from. This ensures that the user is fully informed of which vendor is fulfilling each part of their order. Behind the scenes, as the user adds or removes items from their cart, the system dynamically updates the cart to reflect any changes. The backend continuously checks the inventory of each vendor to ensure that the selected products are still available and accurately priced. If a product becomes unavailable or the price changes after selection, the system automatically alerts the user, prompting them to either select a different item or accept the updated pricing. The shopping cart also provides a breakdown of the items by vendor, so the user can easily review what they are purchasing from each source. For example, products selected from vendor 422 may be displayed under a separate heading, followed by items from vendor 424, and so on. This vendor-specific organization helps users understand the origin of each product, making it easier to compare their selections, review shipping details, and verify that all chosen items are accounted for. Before proceeding to checkout, the system prompts the user to review their cart thoroughly. This is a crucial step, as the user can verify that they have selected the correct quantities, sizes, and variations of each product. Additionally, the user can check that the prices from the different vendors align with their expectations. The shopping cart interface allows users to easily modify their selections by updating quantities, removing items, or adding new products if necessary.

Once the user has reviewed and confirmed their cart, the next step is the checkout process. The user simply clicks on the “Check-out and Pay” button, labeled 430 in FIG. 4C. This triggers the payment processing flow, where the system prompts the user to enter their payment details. Behind the scenes, the system connects to a secure payment gateway to handle the transaction. The payment gateway facilitates the transfer of funds from the user's account to the vendors. It supports a variety of payment methods, including credit cards, digital wallets, and other online payment systems, ensuring flexibility for the user. Upon successful payment, the system sends an order confirmation to the user, detailing the items purchased, the vendors involved, and the total amount paid. This confirmation serves as a receipt and also includes an estimated delivery timeline, providing the user with transparency on when to expect their items to arrive. Simultaneously, the system sends order details to the individual vendors, instructing them to begin processing the items for shipment. Each vendor receives a notification with the relevant details for their part of the order, including the products to be packed and shipped. This ensures that the fulfillment process is well-coordinated across all vendors involved.

As illustrated in FIG. 4D, the system, after receiving the payment, provides the user with a comprehensive payment confirmation that includes both a system-wide confirmation number and individual confirmation numbers from each vendor. These details help the user verify their order before moving to the next stage. Once the user has reviewed and verified the details, they can initiate the pickup process by either pressing a button or using a voice command. This step triggers the personalized UAV to begin collecting the purchased items from the vendors, ensuring an efficient, automated process that spans from payment to delivery. The entire process is designed to be seamless, intuitive, and efficient, ensuring a smooth experience for the user from payment to pickup.

Once the payment process is successfully completed, the system immediately generates and displays a complete payment confirmation screen, labeled as 432 in the figure. This confirmation page provides the user with a comprehensive summary of the entire transaction, including the total amount paid, the individual prices of each item, and a unique system confirmation number (labeled 434) for reference. This confirmation number serves as a record of the payment and acts as a reference point for any future inquiries or issues regarding the order. After the user submits their payment details, the system processes the transaction via a secure payment gateway, which authorizes the payment and transfers funds to the respective vendors. Upon successful completion of the transaction, the system generates the confirmation details and links them to the user's account for easy retrieval. The system confirmation number serves as the identifier for the entire order, ensuring that all items from various vendors are grouped under a single transaction record. In the next step, the system communicates with each vendor's system to process the individual orders. The system sends payment notifications to each vendor, instructing them to confirm the purchase and prepare the items for fulfillment. Each vendor then generates a confirmation number for the respective items. These vendor-specific confirmation numbers are unique identifiers assigned to each purchase, ensuring that the transaction is accurately tracked and processed by the individual vendors. As shown in the figure, the system retrieves and displays these confirmation numbers 436, 438, 440, and 442—for each item purchased from the various vendors.

These confirmation numbers 436, 438, 440, and 442 are crucial for both the user and the system. They allow the user to verify that each order has been successfully processed by the respective vendor, while also serving as a tracking mechanism for the fulfillment process. The confirmation details for each item are shown in the payment confirmation screen, providing transparency and peace of mind for the user. Once the user has reviewed the complete payment confirmation details, including the confirmation numbers from each vendor, the system allows them to verify the accuracy of their purchase. The user is presented with the option to confirm the order by either pressing a button or using a voice command, as shown in FIG. 4D or FIG. 4F. The user can press the button labeled “Push these orders to Personalized UAV for pickup” 444, signaling the system to begin the next stage of the process. This action triggers the system to send the order details to the personalized autonomous UAV (unmanned aerial vehicle), instructing it to retrieve the purchased items from the various vendors. The UAV is equipped with real-time order data, including the vendor locations and items to be collected. Alternatively, the user has the option to issue a voice command, simply saying, “Hey iChoresDrone, go collect the packages.” This voice command can be recognized by the system through the app's built-in voice recognition capabilities. The user can activate this by pressing the microphone icon 446, which activates the voice assistant. Once the command is recognized, the personalized UAV is immediately instructed to begin its collection process, retrieving the items from the respective vendors based on the previously confirmed order details. Once the “Push these orders to Personalized UAV for pickup” button is pressed or the voice command is issued, the system synchronizes with the UAV's autonomous control system, which is now prepared to execute the order. The UAV receives the order data, including the exact products, quantities, and vendor locations, as well as any specific instructions regarding pickup timing, location, and packaging requirements. The system ensures that the UAV is optimized for the most efficient path to collect all the items, taking into account real-time factors such as traffic, weather, and other logistics variables.

### Example Method for Managing Multiple Deliveries

FIG. 4E illustrates an exemplary embodiment of the present invention, showcasing how a user can leverage a mobile application to streamline the process of managing multiple deliveries using their personalized autonomous drone. In one embodiment, the system enables the user to upload existing purchase orders by clicking button 448 to browse the purchase order from their personalized device 110, which were placed across various vendors, suppliers, and eCommerce platforms, into the mobile app. The personalized autonomous drone is then tasked with collecting these purchased items from multiple locations, providing a seamless and automated delivery experience.

In one embodiment, the user begins by selecting a variety of products from different vendors, suppliers, and eCommerce partners. These purchases are made directly through the websites of these vendors or partners, where the user completes the transaction and makes payment through the respective online payment systems available on the sites. After the payment is processed and confirmed, the user proceeds to upload their purchase orders into the mobile application by pressing upload button 450.

Once the purchase orders are uploaded, the mobile app performs data parsing to extract key details from each order. This includes important information such as order confirmation numbers, descriptions of the purchased items, quantities, and the geographic coordinates (latitude and longitude) of each vendor, supplier, or eCommerce partner's location. The system ensures that all relevant order information is accurately captured and organized.

After processing the uploaded order details, including the confirmation numbers, item descriptions, and vendor coordinates, the mobile application sends this parsed data to the user's personalized autonomous drone. This allows the drone to have all the necessary information to efficiently collect the ordered products from each designated store or vendor location.

The app 115 acts as the critical intermediary between the user's purchase activities and the drone's delivery operations. It efficiently organizes and transmits the necessary data to the autonomous drone, ensuring that it is equipped with accurate, up-to-date information regarding the purchased items, their locations, and delivery requirements. With this detailed information, the drone can autonomously navigate to each vendor, pick up the items, and deliver them to the user's specified location, optimizing the entire order fulfillment process and creating a highly personalized, automated delivery experience.

As illustrated in FIG. 4F, the mobile application provides the user with a comprehensive and detailed summary of all the relevant purchase order information that has been parsed and extracted 452. This summary includes essential details obtained from the uploaded purchase orders, such as the unique order confirmation numbers (such as 454, 456, 458), a list of the purchased items, quantities, and the precise geographic coordinates of the vendor locations. Before moving forward, the user is given the opportunity to review and verify all the details to ensure that they are accurate and complete. This step serves as a final check, ensuring that the information displayed in the app matches the user's expectations before the data is sent to the personalized autonomous drone for item collection.

Once the user has thoroughly reviewed and confirmed that all the details are correct, they can initiate the collection process. This can be done either by tapping a button labeled “Push them to drone to pick it up” 444 within the app or by issuing a voice command, such as “Hey iChoresDrone, go and pick it up” by pressing microphone icon 446. Upon receiving this request, the drone is signaled to begin its task of retrieving the purchased items from the designated stores, initiating the next phase of the process.

Upon receiving the user's command—whether through the mobile app or via voice input—the personalized autonomous drone retrieves all relevant data associated with the order, including the order confirmation details, a description of the items, and the precise geographic coordinates for each vendor location. The drone processes this information and uses it to calculate the most efficient travel path to each store, taking into account the geographical locations provided.

At the same time, the drone establishes connections with the point-of-sale (PoS) systems of the involved retail vendors, suppliers, and e-commerce partners via API calls. These API calls allow the drone to access real-time information about item availability, any specific logistics related to the pickup process, and potential delivery options. This integration with the PoS systems ensures that the drone is synchronized with the vendors'systems, allowing for a seamless and coordinated experience from pickup to delivery.

Once the drone has confirmed the logistics and calculated the optimal travel path, it proceeds to visit each store, collects the items specified in the order, and prepares them for delivery to the user's designated address. Throughout this process, the drone operates autonomously, efficiently managing the entire collection and delivery task with minimal human intervention, completing the process in a smooth and coordinated manner.

### Example Method of Operation

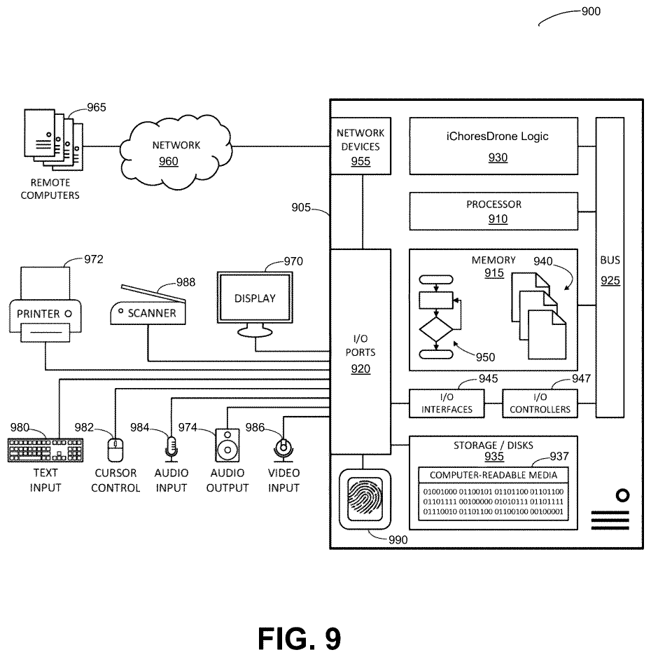

In one embodiment, each step of computer-implemented methods described herein may be performed by a processor (such as processor 910 as shown and described with reference to FIG. 9) of one or more computing devices (i) accessing memory (such as memory 915 and/or other computing device components shown and described with reference to FIG. 9) and (ii) configured with logic to cause the system to execute the step of the method (such as iChoresDrone logic 930 shown and described with reference to FIG. 9). For example, the processor accesses and reads from or writes to the memory to perform the steps of the computer-implemented methods described herein. These steps may include (i) retrieving any necessary information, (ii) calculating, determining, generating, classifying, or otherwise creating any data, and (iii) storing for subsequent use any data calculated, determined, generated, classified, or otherwise created. References to storage or storing indicate storage as a data structure in memory or storage/disks of a computing device (such as memory 915, or storage/disks 935 of computing device 905 or remote computers 965 shown and described with reference to FIG. 9 and described with reference to FIG. 1).

In one embodiment, each subsequent step of a method commences automatically in response to parsing a signal received or stored data retrieved indicating that the previous step has been performed at least to the extent necessary for the subsequent step to commence. Generally, the signal received or the stored data retrieved indicates completion of the previous step.

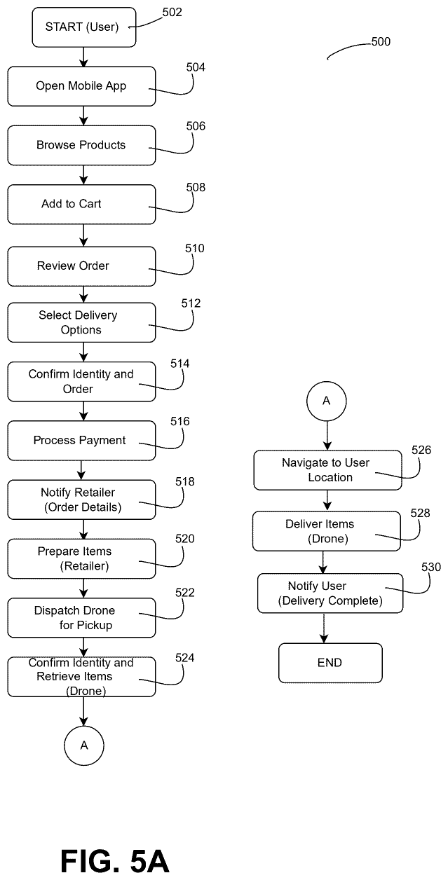

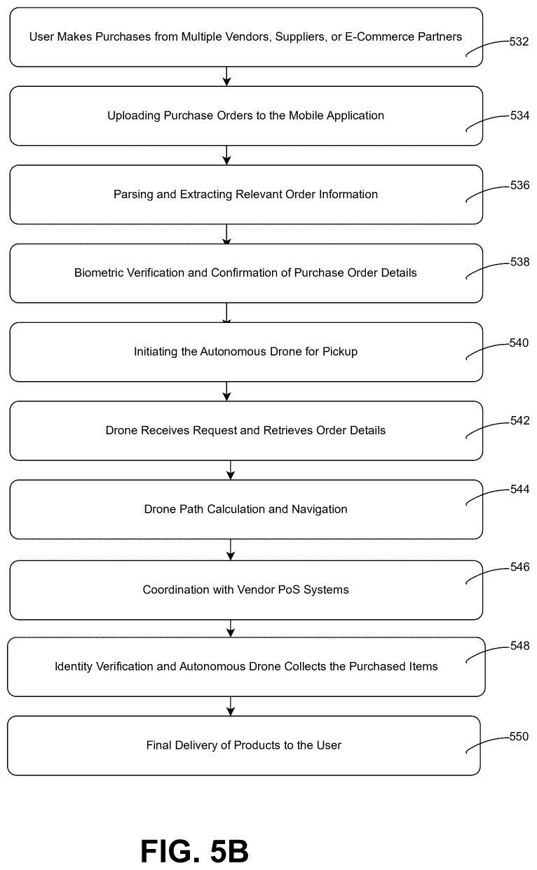

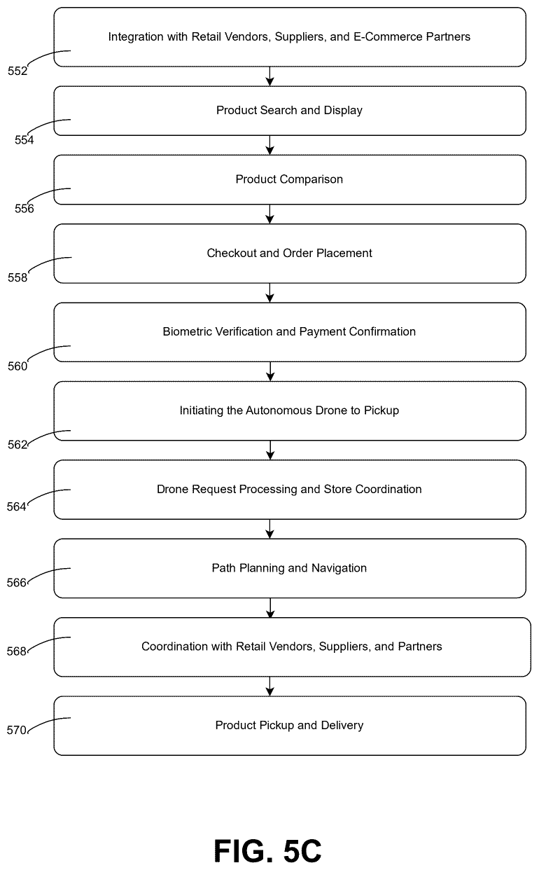

FIG. 5A illustrates one embodiment of a method 500 associated with user-friendly and secure e-commerce process, incorporating biometric verification for secure transactions, product selection, and payment. Once the order is confirmed, the retailer prepares the items and dispatches a drone for delivery. In one embodiment, the steps of method 500 are performed by app 115, a user's personalized autonomous UAV device 130 as shown and described with reference to FIG. 1. In one embodiment, app 115, a user's personalized autonomous UAV device 130 are configured with the iChoresDrone logic 930. In one embodiment, app 115, user's personalized autonomous UAV device are the module of a special purpose computing device configured with iChoresDrone logic 930. In one embodiment, biometric multi-factor authentication across a user is enabled by the steps of method 500, where such was not previously possible to be performed by computing devices. Further, the system enables the biometric multi-factor authentication across a user in real time, where the biometric private key is generated only at the time of an access request, increasing security, and leaving no opportunity for a malicious party to intercept the biometric private key.

The steps of method 500 describes the complete e-commerce process where a user purchases products through an app 115, with the final delivery completed by a drone. The steps also include biometric verification to ensure user security during the transaction process. In block 502, the process begins when the user decides to make a purchase on the e-commerce platform. This is the point where the user's interaction starts.

In block 504, The user opens the mobile application of the e-commerce platform. This could involve unlocking the device and launching the app where they can browse available products. As a security measure, the app prompts the user for biometric verification (such as fingerprint or facial recognition) to confirm their identity. This step ensures that the user is authorized to make the transaction. In block 506,

After successful verification, the user can browse through the catalog of available products. They can filter, search, and explore items of interest to add to their cart. In block 508, Once the user finds a product they want to purchase, they can add it to their shopping cart. The user can continue browsing and adding more items to the cart as needed.

In block 510, After adding products to the cart, the user reviews their order. This includes verifying the quantity, price, and product details to ensure everything is correct before proceeding. In block 512, The user is presented with various delivery options. These could include choices for delivery speed, delivery method (e.g., standard delivery or drone delivery), and delivery address (if not pre-saved). In block 514, Once the user has selected the delivery options and reviewed the cart, they confirm the order. This is the final step before the payment process begins. In block 516, The payment process is initiated. The user chooses their preferred payment method (e.g., credit/debit card, digital wallet, etc.), and the payment is processed securely through the app.

In block 518, After payment confirmation, the e-commerce system notifies the retailer (or warehouse) with the order details, including the items purchased, delivery options, and customer information. In block 520, The retailer or warehouse begins preparing the items for dispatch. This involves picking, packing, and ensuring that the order is ready for delivery. This step may also include quality checks and packaging. In block 522, Once the items are ready, a drone is dispatched to the retailer's location for pickup. The drone is programmed to go to the designated warehouse or store and collect the prepared order. In block 524, The drone arrives at the retailer's location, retrieves the packaged items, and securely loads them onto the drone for transport to the user.

In block 526, The drone navigates to the user's location based on the provided address. During this stage, the drone may follow specific routes or be controlled remotely to avoid obstacles and ensure safe delivery. In block 528, The drone arrives at the user's location and delivers the items. Depending on the delivery method, the drone may either land at a specific point (e.g., user's home or designated delivery area) or notify the user to come to the delivery spot. In block 530, After successfully delivering the items, the drone or the app sends a notification to the user to inform them that the delivery has been completed. The user may be prompted to confirm receipt of the order or rate the delivery experience. In block 532, The process concludes once the user has received the items and the transaction is complete. The user may choose to exit the app, leaving the process finished. The steps of method 500 describes a user-friendly and secure e-commerce process, incorporating biometric verification for secure transactions, product selection, and payment. Once the order is confirmed, the retailer prepares the items and dispatches a drone for delivery. The drone then navigates to the user's location and delivers the items directly, with the process concluding when the user is notified of the completed delivery.

### Example of Uploading Multiple Purchase Orders to Pick Up

FIG. 5B illustrates one of the embodiments of the present invention as it offers an integrated system that allows users to seamlessly purchase products from a variety of vendors, suppliers, and e-commerce partners, and then use a personalized autonomous drone for delivery pickup from multiple store locations. Below is a step-by-step description of the process, outlining how the system works from the user's product selection and purchase to the final delivery via the autonomous drone. This embodiment expands the functionality of the invention by allowing users to upload existing purchase orders from multiple vendors, suppliers, and e-commerce platforms into the mobile application. Once the order details are uploaded, the system ensures that the personalized autonomous drone can efficiently collect the purchased items from different store locations and deliver them to the user. This process enhances the flexibility and convenience of the autonomous delivery system, offering users the ability to manage and retrieve their purchases from various sources in a streamlined and automated manner. The system's integration with vendor PoS systems and its ability to compute optimized travel paths ensure that the drone can efficiently collect all items and provide a seamless delivery experience for the user, enhancing both the shopping and delivery process.

In block 532, User Makes Purchases from Multiple Vendors, Suppliers, or E-Commerce Partners. In this embodiment, users can purchase products from multiple sources, such as retail vendors, suppliers, or e-commerce platforms. The purchase is made directly on each vendor's or platform's website, and the user completes the payment through the respective website. The user selects and purchases multiple products from different vendors or e-commerce platforms, completing the payment on each vendor's platform. The user successfully purchases items from a variety of sources, completing individual payments on each website.

In block 534, Once the user has completed their purchases, the next step involves uploading the purchase order details into the mobile application. Users can upload the order details either manually or through an automatic extraction feature where the app pulls the order information from confirmation emails or digital receipts. The user uploads the order confirmation numbers and other relevant details, including product information, from each vendor or e-commerce partner. The mobile app processes the uploaded purchase orders, extracting critical details such as order confirmation numbers, product information, and vendor details.

In block 536, Upon receiving the uploaded purchase orders, the mobile application parses the order details to extract key data, including: Order Confirmation Numbers: Unique identifiers that help track and verify the individual orders. Product Details: Information such as item names, quantities, and special instructions. Geographical Coordinates of Vendor Locations: Latitude and longitude data for the stores, suppliers, or partners that will enable the autonomous drone to navigate to the correct pickup location. The mobile application extracts and consolidates order details, including confirmation numbers, product descriptions, quantities, and the geographical coordinates of the store locations. The system generates a dataset with all necessary details for the drone to collect the items, including product details and location information for each vendor.

In block 538, before the personalized autonomous drone is dispatched to collect the items, the mobile app displays a verification screen to the user. This screen shows the parsed order details, including: The order confirmation numbers, The list of purchased products, The geographical coordinates of the vendor or supplier locations. The user is prompted to confirm that all information is accurate before proceeding. The user reviews the parsed purchase order details for accuracy and confirms the information. Once verified, the user confirms the details, ensuring the drone has accurate data for the collection task.

In block 540, Once the purchase orders are confirmed, the user can initiate the pickup process by either clicking a button in the mobile app or using a voice command to direct the personalized autonomous drone to begin its task. The user may click “Push them to drone to pick it up” or say “Hey iChoresDrone, go and pick it up.” The user initiates the drone request either through the mobile app or by issuing a voice command. The mobile application sends the necessary information, including order details and vendor location coordinates, to the autonomous drone, triggering it to begin the collection process.

In block 542, Upon receiving the request, the autonomous drone retrieves the necessary order details, including the purchase order confirmation, product details, and vendor geocoordinates, from the mobile application. This data is used to guide the drone to the correct store locations for each item. The drone retrieves purchase order information and vendor geolocation data from the app. The drone has all necessary data, including product details and store locations, to proceed with the pickup.

In block 544, With the order and location data in hand, the autonomous drone now calculates an optimal path to visit each store or vendor. The drone uses the geographic coordinates provided for each store to plot an efficient travel route, minimizing the total travel time or distance to ensure quick pickups. The drone's navigation system calculates the best route using algorithms designed to optimize travel based on store locations. The drone receives an optimized travel path that connects all store locations in the most efficient order.

In block 546, While traveling to each store, the autonomous drone simultaneously communicates with each participating vendor's Point of Sale (PoS) system. By sending API requests to the PoS systems, the drone ensures that the products are ready for pickup when it arrives at each store. The drone communicates with each store's PoS system to coordinate the product retrieval. The vendor is notified in real-time to prepare the ordered products for pickup, ensuring smooth and efficient retrieval when the drone arrives.

In block 548, Upon arrival at each store, the drone verifies the order using the vendor's PoS system, ensuring that the correct products are collected. The drone then retrieves the items and prepares to move on to the next store or to complete the pickup process. The drone arrives at the store, verifies the purchase order, and collects the items. The drone successfully picks up the purchased products and continues its journey to the next location, or it heads towards the final delivery point if all items have been collected.

In block 550, After collecting all the purchased items from the various stores, the drone navigates back to the user's designated delivery location. The delivery can be made to the user's home, an office, or another specified drop-off point. Upon arrival, the drone delivers the items to the user, completing the transaction. The drone delivers the collected items to the user's designated location, as specified during the checkout or via input in the app. The drone successfully delivers all items to the user, completing the order from product discovery and purchase to final delivery.

### Example Method of Retail Vendors, Suppliers, and E-Commerce Partners Integration

FIG. 5C illustrates an exemplary embodiment of the present invention, which facilitates seamless integration with local retail vendors, suppliers, and e-commerce partners through a set of integration endpoints. This invention allows for the retrieval of product catalogs from various sources by invoking their respective application programming interfaces (APIs). When a user initiates a product search through the mobile application, the application queries the integrated systems of multiple retail vendors, suppliers, and e-commerce partners. In response, the application displays detailed product information, including price and descriptions, sourced from these various vendors and partners. The user is then able to compare the prices and product details across different vendors and make an informed purchasing decision. Upon checkout, whether for products from a single vendor or multiple sources, the system processes the user's order by sending requests to the respective vendors, suppliers, and partners on behalf of the user. The system also facilitates payment processing, ensuring the correct funds are transferred to the respective parties according to the user's purchase selections. Once payment is successfully processed, the user is given the option to initiate a personalized autonomous drone for order collection. The user may either select the “push them to drone to pick it up” option within the mobile app or issue a voice command such as “Hey iChoresDrone, go and pick it up” to initiate the request. Upon receiving the request, the personalized autonomous drone communicates with the central server to retrieve relevant details regarding the user's purchase orders and the geographical locations of the associated stores. The server provides the necessary data, including the confirmation of the purchase order, detailed information about the user's orders, and the geographical coordinates of each participating store. Using this information, the autonomous drone computes an optimized navigational path to visit each store based on their geographic locations. At the same time, the drone invokes API calls to the retail vendors', suppliers', and partners'point-of-sale (PoS) systems to synchronize delivery options and logistics information, ensuring the efficient and timely retrieval of the purchased products. This integrated, automated system provides a streamlined, user-friendly experience for shopping, purchasing, and delivery, leveraging both e-commerce and autonomous drone technology to enhance convenience and efficiency.

In block 552, the present invention enables seamless integration with various retail vendors, suppliers, and e-commerce partners through dedicated integration endpoints. These endpoints facilitate data exchange by invoking the respective application programming interfaces (APIs) of each partner. These APIs allow the system to retrieve product catalogs, pricing details, stock availability, and other relevant product information from each partner's system. The invention retrieves product catalogs from multiple sources in real-time by invoking API calls to these retail vendors, suppliers, and e-commerce platforms. A unified, consolidated list of available products, including prices, descriptions, and other relevant details, is collected from various sources.

In block 554, Once the integration is in place, the mobile application enables the user to search for products. The user enters a search query within the mobile application, and the system retrieves relevant results based on product names, categories, or keywords. The search results are drawn from the integrated retail vendors, suppliers, and e-commerce partners. The mobile application queries the consolidated data pool from all integrated partners based on the user's search query. The mobile application displays the product listings, showing relevant details such as product names, descriptions, prices, and availability from each integrated partner.

In block 556, The user can compare the prices and features of the same product across different retail vendors, suppliers, and e-commerce partners. The application displays this information side-by-side, enabling the user to make an informed decision. The user browses the search results and selects one or more products to compare. The application presents the comparison view, showing the different prices, product details, and other relevant information from each vendor or partner.

In block 558, Once the user selects a product or multiple products for purchase, they proceed to checkout. At this stage, the user can either purchase products from a single vendor or from multiple vendors, suppliers, or e-commerce partners. The user adds selected products to the shopping cart and proceeds to the checkout process. The application sends order requests to the respective vendors, suppliers, or partners for the purchased items, ensuring that each order is processed by the correct party. The payment is also processed through the application, with funds being transferred to the appropriate vendor(s).

In block 560, After completing the checkout process, the user provides payment details, and the application processes the payment through a secure transaction system. Once the payment is confirmed, the system notifies the user that the payment has been successfully processed. The user completes the payment, and the system verifies the payment details. Payment confirmation is received by the system, and the user is notified of successful payment processing.

In block 562, After the payment is confirmed, the user is presented with an option to initiate the autonomous drone to pick up the purchased items. The user can either click on a button in the mobile app, selecting the option to “push them to drone to pick it up,” or issue a voice command such as “Hey iChoresDrone, go and pick it up.” The user either selects the drone option in the app or gives a voice command to the system. The application sends a request to the personalized autonomous drone to pick up the purchased items from the respective stores.

In block 564, Upon receiving the request from the user, the personalized autonomous drone communicates with the central server. The server processes the request and retrieves necessary information, such as: Purchase Order Details: A detailed list of the items the user has purchased. Store Geolocation Data: Geographical coordinates (latitude and longitude) of the stores or vendors from which the products were purchased. The autonomous drone requests purchase order details and store geolocation data from the central server. The server responds with the required data, including the purchase order details and the geographic coordinates of the respective stores.

In block 566, With the purchase order details and store locations in hand, the autonomous drone now computes an optimal navigation route to visit each store. The drone uses the geocoordinates of each store to plot a travel path that minimizes travel time or distance, ensuring an efficient pickup process. The drone's onboard system computes the optimal path to each store based on the geocoordinates and navigational algorithms. The drone receives an optimized travel path that guides it to each store to retrieve the purchased products.

In block 568, While enroute to the stores, the autonomous drone simultaneously invokes API calls to each retail vendor's, supplier's, or partner's point-of-sale (PoS) system. This is done to synchronize the logistics of the pickup, ensuring that the store is prepared for the arrival of the drone and that the products are ready for collection. The drone communicates with each vendor's PoS system to coordinate product retrieval, ensuring the store is prepared for the drone's arrival. The store is notified in real-time of the impending drone pickup, and the necessary logistics, such as packaging and order confirmation, are arranged. Once the drone arrives at the store, it performs the product pickup by communicating with the store's PoS system to verify the order and retrieve the purchased items. The drone then transports the products back to the user's location or designated drop-off point. The drone arrives at each store, verifies the order, and retrieves the products. The drone collects the ordered products and prepares for delivery to the user.

In block 570, After collecting all purchased items, the drone navigates back to the user's location or an agreed-upon drop-off point. Upon arrival, the drone delivers the items to the user, completing the transaction. The drone travels to the user's designated drop-off location, either based on a predefined address or user input. The drone delivers the purchased items to the user, completing the entire process from product discovery to delivery.

In one embodiment, the present invention provides a fully integrated system that connects e-commerce platforms, local retail vendors, and suppliers with autonomous drone delivery technology. By leveraging API integrations, a user-friendly mobile application, and autonomous navigation systems, the invention streamlines the process of discovering, purchasing, and receiving products from multiple vendors, all while utilizing autonomous drones for efficient and automated delivery. This system improves the overall shopping experience, offering speed, convenience, and efficiency through automation at every stage of the process, from product search to final delivery.

### Example User's Personalized Autonomous Drone Operation

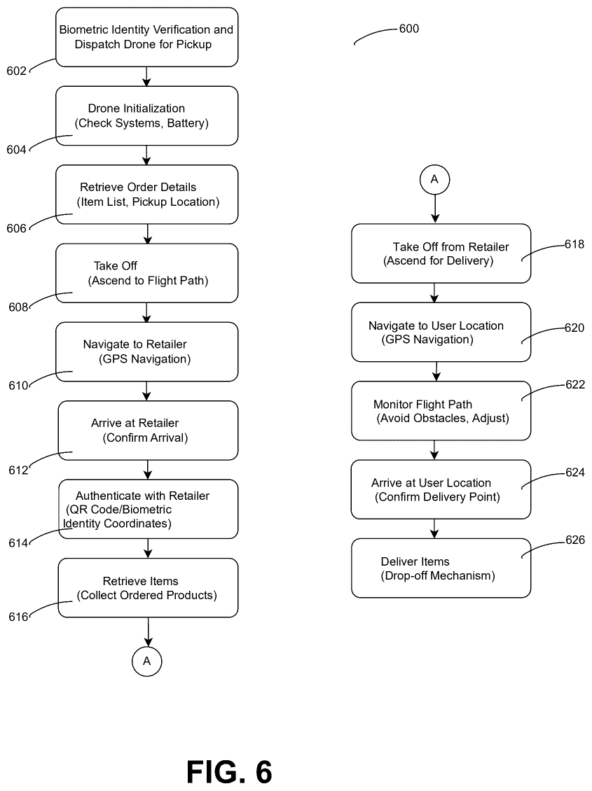

FIG. 6 illustrates one embodiment of a method 600 for user's personalized autonomous drone performs all necessary biometric identity verification and authentication steps before proceeding with any tasks, ensuring security and personalized service at every stage of the process, from the pickup to the delivery. In block 602, At the beginning of the process, the personalized autonomous drone system initiates the biometric identity verification step. Before the drone can proceed with any task, it must authenticate the user's identity to ensure that the request to dispatch the drone is legitimate. The system prompts the user to authenticate themselves through their biometric data, which could include a fingerprint scan, facial recognition, or retinal scan, depending on the user's preferences and setup. The drone's onboard biometric verification system compares the input biometric data against the stored biometric private keys associated with the user's registered profile. This could involve: Scanning the user's fingerprint and matching it with the registered data. Verifying the user's facial features (e.g., distance between eyes, nose, etc.). Analyzing the user's retina or iris patterns. If the biometric data matches, the system will grant access. If the biometric validation fails, access will be denied, and the user will be asked to re-authenticate. Once the user's identity is validated, the system then triggers the drone dispatch to pick up the product as requested by the user.

In block 604, Upon successful biometric authentication, the drone will perform an initialization sequence to prepare for the flight. The drone's onboard systems will perform a diagnostic check to ensure all components are functioning correctly. This includes checking the flight control system, communication systems, and sensor integrity. The system will check the battery level to ensure there is enough power to complete the task. If the battery is low, the drone will automatically return to its charging station. Additional checks might include verifying the GPS system, altimeter, and obstacle avoidance sensors to ensure the drone can safely navigate during flight. Once the drone's systems are verified to be functional, the drone will prepare for takeoff.

In block 606, Before proceeding with the flight, the drone retrieves order details from the user's request. Retrieve Order Data: The drone communicates with the user's personalized drone system to fetch the details of the items that need to be picked up. This includes: A list of ordered products. The pickup location of the retailer or vendor from which the items need to be collected. Geospatial Data: The system also retrieves geospatial coordinates (e.g., latitude and longitude) for both the pickup location and the delivery location, ensuring that the drone can navigate accurately during the flight. Once the order details are loaded into the system, the drone is ready to take off.

In block 608, At this stage, the drone initiates takeoff to begin the delivery journey. The drone performs a vertical takeoff and ascends to a predetermined altitude, typically for avoiding ground-based obstacles and ensuring clear airspace. The drone uses pre-programmed flight paths or real-time navigation data to begin the journey toward the pickup location. Once the drone has achieved the necessary altitude and stabilized its position, it begins to navigate toward the retailer's location.

In block 610, During the flight, the drone utilizes GPS-based navigation to guide it to the retailer's location. The drone uses geospatial data from its internal GPS system to follow a precise route to the retailer's location, considering real-time data such as weather conditions and possible airspace restrictions. The drone continuously monitors its surroundings using lidar, sonar, and vision sensors to detect obstacles and adjust its path as necessary. The drone autonomously follows the route to ensure it arrives safely and on time.

In block 612, Upon nearing the retailer, the drone confirms its arrival. The drone uses its GPS system and possibly visual recognition to ensure it has arrived at the correct retailer location. The system verifies its position against the predefined coordinates and confirms that it is at the right place to pick up the order. At this point, the drone is ready to authenticate with the retailer and proceed with the product collection.

In block 614, To ensure secure and correct product pickup, the drone must authenticate with the retailer. The drone can authenticate with the retailer using either a QR code scan or biometric identity verification. The drone scans a QR code provided by the retailer, confirming the pickup details and authorization. Alternatively, the drone may authenticate the retailer's representative using biometric data such as fingerprint or facial recognition, verifying that the representative is authorized to hand over the goods. Once authenticated, the drone can proceed to retrieve the ordered products.

In block 616, With the retailer authentication confirmed, the drone retrieves the items. The drone autonomously moves to the designated collection point at the retailer, where it will collect the products. The items are stored in the drone's cargo compartment or specialized storage area, ensuring the safe transport of goods. The drone confirms that the correct items have been retrieved by cross-referencing the order details from the previous step. Once the items are collected, the drone prepares to take off for the next stage of the journey.

In block 618, The drone ascends once more, preparing to deliver the collected items to the user. The drone ascends to the required flight altitude, avoiding local obstacles such as buildings or trees. Based on the real-time flight conditions, the drone may adjust its flight path to optimize speed, safety, and delivery efficiency. Once airborne, the drone is set to navigate to the user's delivery location.

In block 620, With the delivery route loaded, the drone begins navigating to the user's location. The drone uses its GPS system to navigate to the delivery address, tracking the most efficient route while avoiding obstacles. The drone adjusts its flight path as needed based on real-time conditions, such as changes in weather or air traffic. The system continually monitors the drone's position to ensure it reaches the destination safely.

In block 622, During the flight, the drone monitors its flight path and makes real-time adjustments. The drone's obstacle avoidance system constantly scans for potential threats, such as birds, buildings, or other aircraft. If an obstacle is detected, the drone will make autonomous adjustments to its altitude or course to avoid collision. This ensures a smooth and safe flight throughout the entire journey.

In block 624, Upon reaching the user's delivery point, the drone confirms that it has arrived at the correct location. The drone cross-references its GPS coordinates with the delivery address stored in the system, confirming it is at the right location. The system may also use visual recognition or QR code scanning to confirm the user's identity or the delivery point. Once the delivery location is verified, the drone prepares to drop off the items.

In block 626, At the final stage of the process, the drone delivers the items to the user. The drone uses its drop-off mechanism (e.g., a compartment door, claw, or platform) to securely release the items at the designated location . The system confirms that the items have been delivered and records the event in the user's order history for future reference. Once the delivery is completed, the drone may return to its base or await further tasks.

This detailed sequence ensures that the user's personalized autonomous drone performs all necessary biometric identity verification and authentication steps before proceeding with any tasks, ensuring security and personalized service at every stage of the process, from the pickup to the delivery.

### Example Method for Biometric Private Key Generation

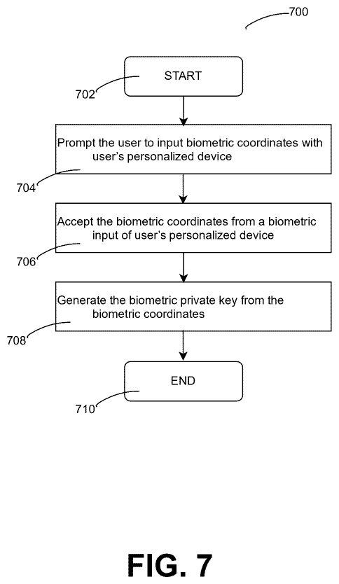

FIG. 7 illustrates one embodiment of a method 700 for biometric private key generation associated with provision of user identity for the present invention with user biometrics. In one embodiment, the steps of method 700 are performed by user's personalized device 110 specially configured as shown and described with reference to FIG. 1. In one embodiment, user's personalized device 110 is a special purpose computing device (such as mobile device) configured with the present invention logic 115. In one embodiment, fingerprint coordinate generator, retinal coordinate generator, facial coordinate generator, and biometric private key generator modules of Biometric Manager 210 are module of a special purpose computing device (such as mobile device) configured with the present invention logic 115.

The method 700 may be initiated automatically based on various triggers, such as in response to receiving a signal over a network or parsing stored data indicating that (i) a user (or administrator) of system 100 has initiated method 300, (ii) that method 700 is scheduled to be initiated at defined times or time intervals, (iii) that user's personalized device 110 has received a request for a biometric private key of a user (or administrator) of system 100 due to a request to access the present invention features such as Personalized autonomous UAV device interaction, product browsing, order placement, initiating the Personalized autonomous UAV device to collect package collection using that user's identity, or (iv) that user's personalized device 110 has received a request for a biometric private key of a user (or administrator) of system 100 due to a request to register the user's identity with present invention server 160. The method 700 initiates at START block 705 in response to parsing a signal received or stored data retrieved and determining that the signal or stored data indicates that the method 700 should begin. Processing continues to process block 710.

At process block 710, the processor prompts the user to input his biometric coordinates with the mobile device.

In one embodiment, a mobile application 115, is installed on a user's personalized device, such as mobile device 110. In one embodiment, the mobile application 115 is listening for requests for a biometric key of the user. In one embodiment, the mobile application 115 is launched in response to receiving the request. Upon receiving the request, the user's personalized device audibly, tactilely, and/or visually prompts the user to input his biometric coordinates. For example, the user's personalized device may make a sound that indicates that the request for biometric coordinates has been received as an audible prompt. For example, the user's personalized device may vibrate in a manner that indicates that the request for biometric coordinates has been received as a tactile prompt. For example, the user's personalized device may display a graphical user interface (GUI) or illuminate an indicator light as a visual prompt. In one embodiment, the GUI is a GUI 200 of the mobile application 115 installed on the mobile device 110. In one embodiment, the GUI 200 displays instructions indicating that a request for a biometric key of the user has been received and instructing the user to provide his or her biometric coordinates. In one embodiment, where the biometric coordinates are fingerprint coordinates, the instructions direct the user to place their fingerprint over a fingerprint sensor of the mobile device. In one embodiment, where the biometric coordinates are retinal coordinates, the instructions direct the user to place their eye in front of a camera of the mobile device, for example in a position close to the camera to allow the camera to image the retina through the pupil of the user's eye. In one embodiment, where the biometric coordinates are facial coordinates, the instructions direct the user to place their face in front of a camera of the mobile device, for example in a position that allows the camera to image the user's face.

Once the processor has thus completed prompting the user to input his biometric coordinates with the mobile device, processing at process block 710 completes, and processing continues to process block 715.

At process block 715, the processor accepts the biometric coordinates from a biometric input device of the mobile device 110. In one embodiment, the biometric coordinates from user capture by using user's personalized device 110 camera and sensor (fingerprint scanner, retinal scanner, or camera), for example as a data image or other data structure. The mobile application 115 on the mobile device 110 then converts the data from the image or other data structure to a set of coordinates on a graph representing the biometric input, also referred to herein as biometric coordinates. In one embodiment, where the biometric input is a fingerprint, fingerprint coordinates are generated by a fingerprint coordinate generator module of Biometric Manager logic 210. In one embodiment, the fingerprint coordinate generator module of Biometric Manager logic 210 identifies relative locations of fingerprint characteristics such as crossovers, cores, bifurcations, ridge endings, deltas, pores, loops, or whorls within the fingerprint image, and records coordinates of these characteristics on a graph to form the fingerprint coordinates. In one embodiment, where the biometric input is a retinal image, retinal coordinates are generated by a retinal coordinate generator such as retinal coordinate generator module from Biometric Manager 210. In one embodiment, the retinal coordinate generator identifies relative locations of retina characteristics, such as the positions of branches of blood vessels in the retina of the eye. In one embodiment, where the biometric input is a facial image, facial coordinates are generated by a facial coordinate generator such as facial coordinate generator module of Biometric Manager 210. In one embodiment, the facial coordinate generator identifies relative locations of facial characteristics, such as the positions of eyes, nose, mouth, ears, or other facial features. In one embodiment, the locations of the characteristics (whether fingerprint, retinal, facial, or other) is performed by a machine learning (ML) model trained to accurately identify the locations of such characteristics. Once the biometric coordinates have been generated, they are stored as a data structure for subsequent processing. In one embodiment, multiple types of biometric input are captured and converted to coordinates for added security, for example, both retinal and fingerprint coordinates may be captured.

Once the processor has thus completed accepting the biometric coordinates from a biometric input device of the mobile device 110, processing at process block 715 completes, and processing continues to process block 720.

At process block 720, the processor generates the biometric private key from the biometric coordinates by the mobile device.

In one embodiment, a biometric private key generator such as biometric private key generator of Biometric Manager 210 generates the biometric private key token. The biometric coordinates are retrieved from storage. The biometric coordinates are processed to generate a biometric private key from the coordinates. In one embodiment, the biometric coordinates are used as a seed to generate a private key. For example, the entirety of or a portion of one of (i) the binary representation of the biometric coordinates; (ii) the hexadecimal representation of the biometric coordinates, (iii) the ascii string of the biometric coordinates; (iv) the Unicode string of the biometric coordinates; or (v) some other representation of the biometric coordinates are provided as a seed to a key generation module. Key generation module may implement a variety of key generation software, such as HyperCrypt or PuTTY key generators. In one embodiment, the key generation module accepts the seed and returns a public/private key pair where the system is configured to use asymmetric keys as the biometric private key. For example the key generation module may generate the public/private key pair using the Rivest-Shamir-Adleman (RSA) algorithm. Other acceptable asymmetric-key algorithms include Diffie-Hellman, Digital Signature Algorithm (DSA), El Gamal, Elliptic-curve Diffie-Hellman, Elliptic-Curve DSA, and other Elliptic-Curve cryptographic algorithms, Paillier cryptosystem, Cramer-Shoup, and YAK. In one embodiment, the key generation module accepts the seed and returns a private key where the system is configured to use symmetric keys as the biometric private key. For example, the key generation module may generate the private key using the Advanced Encryption Standard (AES) algorithm. Other acceptable symmetric key algorithms may include Blowfish, Camellia, CAST5, ChaCha20, DES, 3DES, Kuznyechik, RC4, Safer, Salsa 20, Serpent, Skipjack, and Twofish. Other methods of using the biometric coordinates to seed generation of a private key are also contemplated by this disclosure. In this way, the biometric private key is generated from one or more of fingerprint biometric coordinates, facial biometric coordinates, and retinal biometric coordinates. The biometric application wraps the newly generated biometric private key in a message for transmission to the requesting entity of the federated identity group. In one embodiment, the message is an X.509 certificate, and the biometric private key is inserted in a field of the certificate, such as the signature field.

Once the processor has thus completed generating the biometric private key from the biometric coordinates by the mobile device, processing at process block 720 completes, and processing continues to END block 725, where process 700 ends.

In one embodiment, the generation of the biometric private key from the biometric coordinates is performed as part of an initial registration process. In one embodiment, the combination of the user's personalized device 110 and the user's biometric coordinates is registered as a possession factor token for multi-factor authentication, as shown and described herein. In one embodiment, the user attempts a login to access resources of a present invention such as Personalized autonomous UAV device, product browsing, order placement, initiating the Personalized autonomous UAV device to collect package collection. In response to the login attempt, the mobile application 115 queries the server 160 in the biometric identity components. In response to finding either (i) that there is no identity established for the user-mobile device combination, (ii) that the identity established for the user-mobile device combination includes records indicating that a prior validation attempt has failed, the server 160 redirects the login request to the user registration components (such as user registration components) of the generating identity using user's biometric coordinates. to complete a registration process. The user registration components present the user with a prompt to complete a registration process, including downloading and installing an app 115 onto the user's personalized device 110. Following installation, the user uses the application 115 to generate the biometric private key for a first time, executing process 700 as part of the initial registration process to authorize the user-mobile device pair as a biometric token device. The app 115 sends the biometric key (in its X.509 certificate wrapper) to the user registration components.

In one embodiment, the registration of the user continues by submitting the biometric private key for inclusion as an initial record in the server 160 associated with the user and the user's personalized device 110. The user registration components receive the biometric key in a message from the app 115 and parse the message to extract the key. The user registration components add the key to an initial record specifically for recording multifactor authentication attempts of the user with the user's personalized device 110. The user registration components add the new record to the server 160 of present invention.

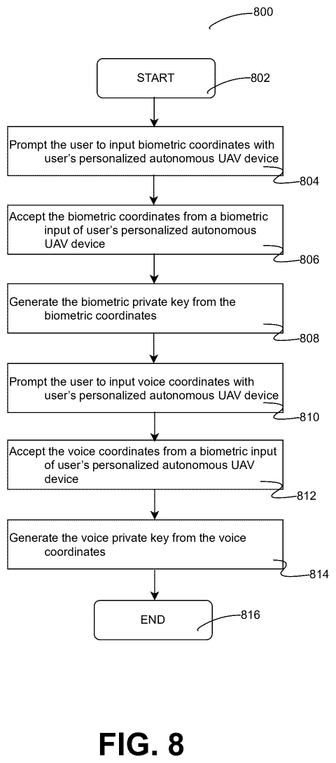

FIG. 8 illustrates one embodiment of a method 800 for enforcing registration of a user identity associated with a personalized autonomous drone system. In this embodiment, the method 800 is performed by biometric identity component of personalized autonomous drone system, which includes modules for biometric validation and identity verification. The drone system is equipped with biometric input scanner device 370 to accept biometric coordinates from user and configured to handle biometric user authentication using data from biometric input scanner device 370, ensuring secure and personalized access to the drone services. The method 800 is triggered by initializing the biometric authentication procedure for the personalized autonomous UAV system. The user will be prompted to input their biometric data to securely register their identity with the drone system, ensuring personalized access to the UAV services as start block 802.

At block 804, the personalized autonomous UAV system's interface will display a prompt to the user, requesting them to provide their biometric data. This prompt may be displayed on the drone's onboard system or communicated via a connected mobile device, smartwatch, or smart home assistant. The system will ask the user to provide fingerprint, facial, or retinal scan coordinates, depending on the biometric method chosen. The system will guide the user through the process of scanning their biometric traits by utilizing the drone's biometric input devices, such as a fingerprint sensor, facial recognition camera, or retina scanner. For example: Fingerprint input: The user places their finger on the fingerprint scanner, where the drone's system captures the unique fingerprint patterns. Facial input:
The system prompts the user to position their face within the camera's view for a facial scan. Retinal input: The drone's retinal scanner will capture a high-definition image of the user's eye to record retinal patterns.

In block 806, the drone's biometric input sensors (fingerprint scanner, facial recognition camera, or retina scanner) will accept the biometric coordinates provided by the user. This could involve: Capturing the user's fingerprint patterns using high-resolution fingerprint sensors. Scanning the user's facial features (such as the shape of the eyes, nose, and mouth) using a camera with facial recognition algorithms. Recording the unique retinal patterns using a retinal scanner. The drone system processes these captured biometric coordinates, converting them into a digital representation that can be used for authentication. This data will be securely stored in the system for future verification purposes.

After the biometric coordinates have been captured and processed, Block 808 involves the generation of a biometric private key. This private key is a cryptographic representation derived from the captured biometric data (such as fingerprint, retinal, or facial scan). The private key is unique to the user and based on the specific biometric data recorded during this authentication step. This key is encrypted and securely stored within the personalized autonomous UAV system. The private key will later be used for verification when the user requests to interact with the drone system, ensuring that the person initiating the request is indeed the registered user.

The biometric private key can be generated through various techniques, such as: Using the fingerprint's unique ridge patterns and generating an encrypted cryptographic key from these patterns. Analyzing the retinal or iris patterns, which are unique to each individual, and deriving a private key. Using facial recognition data, such as the distances between key facial features, to generate a unique encrypted identifier.

In block 810, the system prompts the user to provide an additional layer of voice biometrics to enhance security. The voice command input can be processed using voice recognition software that captures specific patterns in the user's speech, including tone, pitch, cadence, and other unique vocal characteristics. The drone's system will display instructions or initiate a voice recording request through a microphone or voice assistant interface. The user will be instructed to speak a specific phrase or command that is unique to their voice. This additional biometric layer further secures the system and personalizes the user's access.

Once the user has provided their voice input, Block 812 processes the voice coordinates using the drone's voice recognition system. The system will record and analyze the user's voice input to extract unique voiceprint characteristics, such as the frequency and amplitude patterns of the speaker's voice. The system converts these voice characteristics into voice coordinates that serve as a unique identifier, ensuring that only the registered user can issue commands or requests to the drone system using voice commands. The drone will utilize these coordinates to verify the user's identity when a voice command is received.

In block 814, a voice private key is generated from the voice coordinates. Similar to the biometric private key generation, the voice data (which includes specific characteristics of the user's voice such as tone, pitch, cadence, and other patterns) is processed using encryption algorithms. The result is a unique voice private key that can be securely stored and used for future voice authentication when the user issues voice commands to the drone system. This voice private key ensures that voice interactions with the drone system are secure and that only the registered user can issue voice commands to the UAV.

At End block 816, the biometric authentication process concludes, and the user's identity is successfully registered in the drone system. The personalized autonomous UAV system now has the necessary biometric private keys associated with the user's identity, including: Fingerprint private key generated from the fingerprint coordinates. Retinal private key generated from the retinal scan coordinates. Facial private key generated from the facial recognition coordinates. Voice private key generated from the voice coordinates. The system is now ready to authenticate the user and grant them secure access to the personalized autonomous drone services for tasks such as product deliveries, household chores, and other user-defined actions. Future access to the system will involve verifying the user's identity using one or more of these biometric identifiers, ensuring a seamless and secure interaction with the personalized UAV. This process involves multiple biometric modalities (fingerprint, retinal scan, facial recognition, and voice) to enhance security and personalize the user experience with the autonomous UAV system. Each biometric input generates a unique private key, which is used for validation and identity verification every time the user interacts with the drone. This layered authentication ensures that only the rightful user can access and control their personalized autonomous drone

### Selected Embodiments

In one embodiment, a computer-implemented method includes, in response to a request for a household task or product delivery, transmitting a request for biometric authentication from a remote device (such as a smartphone, tablet, or smart home assistant) associated with the registered user of a personalized autonomous drone system. Upon receiving the biometric private key or token, the system validates the biometric data against a stored record in a secure database associated with the user and the remote device. The validation result is stored in the system's secure memory, and access to the personalized autonomous drone system is controlled based on this result: (i) access is denied if the validation fails, or (ii) access is granted if the validation is successful. In another embodiment, the method further includes controlling access to various household services or vendor systems based on the biometric validation result. If validation fails, the system denies access to services like product pickup, delivery, or household chores. If validation is successful, the system enables the requested tasks to be carried out. In one embodiment, generating the biometric private key includes prompting the user to provide biometric data, such as fingerprint, facial recognition, or retinal coordinates, via a biometric input device on their mobile device. The system generates the biometric private key from the received biometric coordinates. In a further embodiment, the method includes registering the user by submitting the biometric private key for inclusion in the system's secure database, enabling the user to authenticate with the personalized autonomous drone system for future requests. In one embodiment, if the validation fails, the system triggers a requirement for re-registration of the user, ensuring that only authorized users can access the system and perform tasks like household chores or receiving deliveries. Re-registration would require the user to input their biometric data again to update their authentication records. In one embodiment, the biometric private key is generated using an encryption standard, or directly based on the user's biometric features, including fingerprint, facial recognition, or retinal scan data. In another embodiment, the system integrates with a server 160 (secure identity provider) to authenticate the user, where the server 160 the biometric private key, records the validation result in the system's secure memory, and grants or denies access to the requested household tasks based on the result. In one embodiment, the method includes maintaining the user's biometric data in a secure memory, ensuring that the data remains protected while still enabling the personalized autonomous drone system to authenticate the user for future task requests. In one embodiment, a computing system including a processor, memory, and computer-readable instructions stores the method. When executed by the computing system, the method controls the authentication and authorization of the personalized autonomous drone system based on the user's biometric data and access request, enabling the drone to perform household chores or facilitate product deliveries. In one embodiment, computer-readable instructions are stored on a non-transitory computer readable medium that, when executed by the processor of a computer in concert with other components of the computer as needed, cause the computer to execute the method. In one embodiment, a computing system including a processor, memory, and a computer readable medium storing computer-readable instructions that, when executed by computing system, cause the computer to execute the method.

### Software Module Embodiments

In general, software instructions are designed to be executed by one or more suitably programmed processor accessing memory, such as by accessing CPU or GPU resources. These software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by a main program for the system, an operating system (OS), or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### Cloud or Enterprise Embodiments

In one embodiment, the present system (such as the personalized autonomous drone system) includes a computing/data processing system comprising a collection of distributed computing applications (such as the eCommerce vendors 150-1-150-N, retail vendors 140-1-140-N Point of Sale (PoS)) for access and use by client computing devices associated with the user (such as the user's personalized device 110) that communicate with each other over a network (such as network 120). The user's personalized autonomous drone system 130 is configured to interact with these systems to process orders, perform household tasks, and execute product deliveries. The applications and computing system may be configured to operate with or be implemented as a cloud-based network computing system, an infrastructure-as-a-service (IaaS), platform-as-a-service (PaaS), or software-as-a-service (SaaS) architecture, or any other type of networked computing solution. In one embodiment, the present system provides at least one or more of the functions disclosed herein, such as order processing, task management, product availability checks, delivery optimization, and biometric user authentication, along with a graphical user interface to access and operate these functions, enabling the user to interact with and control the personalized autonomous drone for their household tasks.

### Computing Device Embodiments

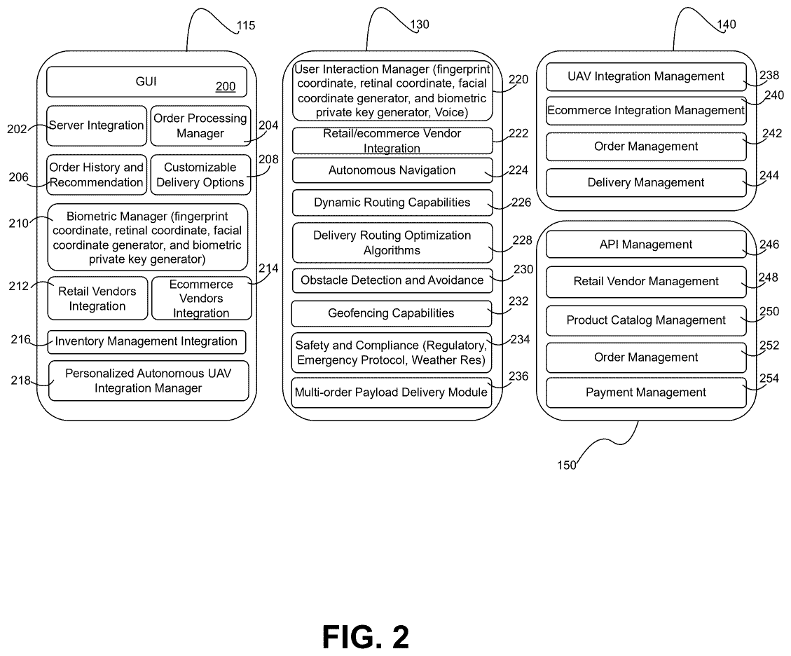

FIG. 9 illustrates an example computing system 900 that is configured and/or programmed as a special purpose computing device with one or more of the example systems and methods described herein, and/or equivalents. The example computing device may be a computer 905 that includes a processor 910, a memory 915, and input/output ports 920 operably connected by a bus 925. In one example, the computer 905 may include iChoresDrone logic 930 configured to facilitate a personalized autonomous drone delivery system that integrates biometric authentication for secure and efficient product collection and delivery with user biometrics similar to the logic, systems, and methods shown and described with reference to FIGS. 1-8. In different examples, the iChoresDrone 930 may be implemented in hardware, a non-transitory computer-readable medium with stored instructions, firmware, and/or combinations thereof. While the iChoresDrone logic 930 is illustrated as a hardware component attached to the bus 925, it is to be appreciated that in other embodiments, the iChoresDrone logic 930 could be implemented in the processor 910, stored in memory 915, or stored in disk 935 on computer-readable media 937.

In one embodiment, the iChoresDrone logic 930 or the computing system 900 is a means (such as, structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to perform provision of decentralized identity with user biometrics as shown and described herein. The means may also be implemented as stored computer executable instructions that are presented to computer 905 as data 940 that are temporarily stored in memory 915 and then executed by processor 910.

The iChoresDrone logic 930 may also provide means (e.g., hardware, non-transitory computer-readable medium that stores executable instructions, firmware) for performing provision of decentralized identity with user biometrics.

Generally describing an example configuration of the computer 905, the processor 910 may be a variety of various processors including dual microprocessor and other multi-processor architectures. A memory 915 may include volatile memory and/or non-volatile memory. Non-volatile memory may include, for example, ROM, PROM, EPROM, EEPROM, and so on. Volatile memory may include, for example, RAM, SRAM, DRAM, and so on. A storage disk 935 may be operably connected to the computer 905 by way of, for example, an input/output (I/O) interface (for example, a card or device) 945 and an input/output port 920 that are controlled by at least an input/output (I/O) controller 947. The disk 935 may be, for example, a magnetic disk drive, a solid-state disk drive, a floppy disk drive, a tape drive, a Zip drive, a flash memory card, a memory stick, and so on. Furthermore, the disk 935 may be a CD-ROM drive, a CD-R drive, a CD-RW drive, a DVD ROM, and so on. The memory 915 can store a process 650 and/or data 940 formatted as one or more data structures, for example. The disk 935 and/or the memory 915 can store an operating system that controls and allocates resources of the computer 905. The computer 905 may interact with, control, and/or be controlled by input/output (I/O) devices via the input/output (I/O) controller 947, the I/O interfaces 945 and the input/output ports 920. The input/output devices include one or more displays 970, printers 972 (such as inkjet, laser, or 3D printers), and audio output devices 974 (such as speakers or headphones), text input devices 980 (such as keyboards), a pointing and selection device 982 (such as mice, trackballs, touchpads, touch screens, joysticks, pointing sticks, stylus mice), audio input devices 984 (such as microphones), video input devices 986 (such as video and still cameras), video cards (not shown), disk 935, network devices 955, fingerprint scanners 990, internet of things sensors (not shown), and so on. The input/output ports 920 may include, for example, serial ports, parallel ports, and USB ports.

The computer 905 can operate in a network environment and thus may be connected to the network devices 955 via the I/O interfaces 945, and/or the I/O ports 920. Through the network devices 955, the computer 905 may interact with a network 960. Through the network 960, the computer 905 may be logically connected to remote computers 965, remote mobile devices, or remote computer-controllable hardware, such as autonomous vehicles 990. Networks with which the computer 905 may interact include, but are not limited to, a LAN, a WAN, and other networks.

### Mobile Device Embodiment

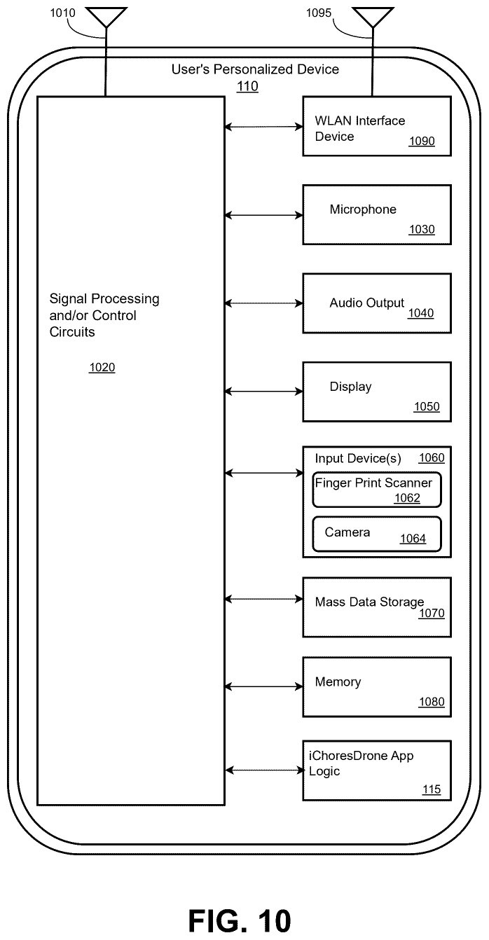

Referring now to FIG. 10, illustrates an example user's personalized device 110 that is configured and/or programmed with one or more of the systems and methods described herein, and/or equivalents. In one example, the user's personalized device 110 may include the iChoresDrone App logic 115 configured to facilitate a personalized autonomous drone delivery system that integrates biometric authentication for secure and efficient product collection and delivery with user biometrics similar to the logic, system, and methods shown and described with reference to shown in FIGS. 1 through 8. Mobile device 110 may include a cellular antenna 1010 to receive or transmit information through a cellular communication network. The example embodiment may implement signal processing and/or control circuits, which are generally identified in FIG. 10 at 1020. In some implementations, the mobile device 110 includes a microphone 1030, an audio output 1040 such as a speaker and/or audio output jack, a display 1050 and/or an input device 1060 such as a keypad, pointing device, touch screen, voice actuation and/or other input devices. In one embodiment, the input devices 1060 also include a fingerprint scanner 1062 for accepting a fingerprint, such as an optical fingerprint scanner, a capacitive fingerprint scanner, or an ultrasonic fingerprint scanner. In one embodiment, the input devices 1060 also include a camera 1064 capable of imaging a retina or imaging a face. In one embodiment, the input devices 1060 also include a dedicated retinal scanner (not shown). The signal processing and/or control circuits 1020 and/or other circuits (not shown) in the mobile device 110 may process data, perform coding and/or encryption, perform calculations, format data and/or perform other cellular phone functions.

The mobile device 110 may communicate with a mass data storage 1070 that stores data in a nonvolatile manner such as in optical and/or magnetic storage devices including, for example, HDDs and/or DVDs. The HDD may be a magnetic HDD having one or more platters, or a solid-state drive (SSD). The mobile device 110 may be connected to a memory 1080 such as RAM, ROM, low latency nonvolatile memory such as flash memory and/or other suitable electronic data storage. The mobile device 110 also may support connections with a wireless local area network (WLAN) through a WLAN network interface 1090. Mobile device 110 may include a WLAN antenna 1095 to receive or transmit information through the WLAN. In this example embodiment, example systems and methods may be implemented using this WLAN network interface 1090, but other arrangements are also possible.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated In blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.
API: application programming interface.
ASIC: application specific integrated circuit.
CA: certifying authority.
CD: compact disk.
CD-R: CD recordable.
CD-RW: CD rewriteable.
CPU: central processing unit.
CSR: certificates signing request.
DVD: digital versatile disk and/or digital video disk.
GPU: graphics processing unit.
HDD: hard disk drive.
HTTP: hypertext transfer protocol.
I/O: input/output.
IAAS: infrastructure-as-a-service.
ICA: intermediate certificate authority.
JKS: Java key store.
JSON: JavaScript object notation.
KMS: key management service.
LAN: local area network.
WLAN: wireless LAN.
MAC: media access control.
MIN: mobile identification number.
ML: machine learning.
NAS: network attached storage.
OCI: Oracle Cloud Infrastructure.
OS: operating system.
PAAS: platform-as-a-service
RAM: random access memory.
DRAM: dynamic RAM.
SRAM: synchronous RAM.
REST: representational state transfer.
ROM: read only memory.
PROM: programmable ROM.
EPROM: erasable PROM.
EEPROM: electrically erasable PROM.
RSA: Rivest-Shamir-Adleman.
SAAS: software-as-a-service.
SOAP: simple object access protocol.
SQL: structured query language.
SSD: solid state drive.
TCP/IP: transmission control protocol/Internet protocol
USB: universal serial bus.
XML: extensible markup language.
WAN: wide area network.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“iChoresDrone”, as used herein, represents a personalized autonomous unmanned aerial vehicle (UAV), or unmanned aircraft system (UAS), commonly known as a drone, is an aircraft with no human pilot, crew, or passengers on board that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, iChoresDrone may include one or more gates, combinations of gates, or other circuit components configured to perform one or more of the disclosed functions. Where multiple components/functionalities are described, it may be possible to incorporate the multiple components/functionalities into one component/functionality. Example., fingerprint coordinate generator, retinal coordinate generator, facial coordinate generator, and biometric private key generator, Voice code generators components/functionalities are incorporated into User Interaction Manager component functionality of iChoresDrone. Similarly, where a single component/functionality is described, it may be possible to distribute that single component/functionality between multiple components/functionalities. In one embodiment, one or more of these iChoresDrone components/functionalities are corresponding structure associated with performing the disclosed and/or claimed functions. Choice of which type of component/functionality to implement may be based on desired system conditions or specifications. iChoresDrone is limited to statutory subject matter under 35 U.S.C. § 101.

“UAV, or “unmanned aerial vehicle”, or “unmanned aircraft system”, or “UAS”, or “Drone” as used herein, represents an aircraft with no human pilot, crew, or passengers on board, includes but is not limited to one or more autonomous aircraft, Quadcopter, Radio-controlled aircraft, Delivery robot, Precision Payload Delivery System, computers or other devices, or combinations of these.

“Application”, or “app”, or “Mobile Application”, or “Mobile App”, as used herein, represents a computer readable instructions that stores into user's personalized device which is a computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent app may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, app may include one or more gates, combinations of gates, or other circuit components configured to perform one or more of the disclosed functions. Where multiple components/functionalities of app are described, it may be possible to incorporate the multiple components/functionalities of app into one component/functionality. Example., fingerprint coordinate generator, retinal coordinate generator, facial coordinate generator, and biometric private key generator, Voice code generators components/functionalities are incorporated into Biometric Manager component functionality of app. Similarly, where a single component/functionality is described, it may be possible to distribute that single component/functionality between multiple components/functionalities. In one embodiment, one or more of these app components/functionalities are corresponding structure associated with performing the disclosed and/or claimed functions. Choice of which type of component/functionality to implement may be based on desired system conditions or specifications. App is limited to statutory subject matter under 35 U.S.C. § 101.

“User”, as used herein, includes but is not limited to one or more persons, computers or other devices, or combinations of these.

The user's personalized device, as used herein, includes but is not limited to one or more digital devices. The term “digital device” generally refers to any hardware device that includes a processor. A digital device may refer to a physical device executing an application or a virtual machine. Examples of digital devices include a computer, a smart assistant, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

1. A personalized autonomous drone system, comprising:
One or more processors; and
memory coupled to the one or more processors, the memory storing instructions, which when executed by the one or more processors, cause the system to perform a method comprising:
configuring the personalized autonomous drone for a registered user, where the system allows the user to place orders for products and household services from multiple vendors, with chores such as product pickup, delivery customized for the user's needs;
assigning biometric access credentials to the system, wherein the biometric access credentials are based on registered biometric data specific to the user, enabling secure access to the system tailored to the user's identity;
uploading purchase orders or service requests from a user's personalized device (such as a smartphone, tablet, or smart home assistant), wherein the orders or requests include product details, service tasks, geospatial data, and specific instructions related to the household chores or deliveries to be performed by the personalized autonomous drone;
receiving a user request from a user's personalized device (such as a smartphone, tablet, or smart home assistant), requesting to initiate product pickup and delivery or any household chore by the personalized autonomous drone;
authenticating the user via biometric data, wherein the system:
receives access requests from remote devices and verifies whether the collected biometric data matches the registered biometric data of the user;
grants access to the personalized autonomous drone system if authentication is successful, and denies access if authentication fails;
enabling the personalized autonomous drone to autonomously perform tasks such as picking up products from various vendor locations based on the uploaded orders or performing specific chores and delivering products to the user's specified location.

2. The personalized autonomous drone system of claim 1, wherein:
the drone system is configured to store multiple registered biometric profiles to enable access by different users in a shared household environment, while maintaining user-specific security and access privileges, ensuring the drone remains dedicated to the registered user's personalized tasks.

3. The personalized autonomous drone system of claim 1, wherein:
the system is configured to allow the registered user to select household products or services from multiple vendors, aggregate the orders or service tasks, and send the purchase details, geospatial data, and task instructions to the personalized autonomous drone for optimized execution of tasks like product pickup, deliveries, or household chores.

4. The personalized autonomous drone system of claim 1, wherein:
the instructions to upload purchase orders and chore instructions further comprise instructions to retrieve product availability data from vendor systems and determine an optimal schedule for product pickup and chore execution based on the user's specified needs and preferences.

5. The personalized autonomous drone system of claim 1, wherein:
the system integrates with external vendor Point of Sale (PoS) systems to confirm product availability, pricing, and task availability before the drone begins product collection or household chore execution, ensuring seamless coordination between the user's household and external service providers.

6. The personalized autonomous drone system of claim 1, wherein:
the personalized autonomous drone uses a combination of GPS, visual recognition, and machine learning algorithms to optimize its flight path during task execution, whether for product collection, delivery, or household chores, adapting to the user's environment and specific task requirements.

7. The personalized autonomous drone system of claim 1, wherein:
the system is further configured to ensure the personalized autonomous drone maintains secure and encrypted communication with the user's device, ensuring the integrity and privacy of personalized tasks and household data such as orders, locations, and biometric credentials.

8. The personalized autonomous drone system of claim 1, wherein:
the system is further configured to collect feedback from the user after task completion, wherein the feedback includes user ratings, preferences, and satisfaction metrics regarding the completed tasks or deliveries;
the drone system uses the collected feedback to adjust and improve future task performance, including optimizing flight paths, task execution strategies, and product collection or delivery processes, to better align with the user's preferences and enhance task efficiency over time.

9. A computing system, comprising:
at least one processor connected to at least one memory;
at least one network interface for communicating with one or more networks;
a non-transitory computer-readable medium storing instructions that, when executed by at least the processor, cause the processor to:
configure a personalized autonomous drone delivery system for a registered user, wherein the system allows the user to place orders for products from multiple vendors and upload purchase orders for product pickup;
assign biometric access credentials to the system for controlling remote access, wherein the biometric access credentials are based on registered biometric data specific to the user;
authenticate the user by verifying the collected biometric data with the registered biometric data, wherein:
system receives access requests from remote devices requesting to initiate the delivery process;
system compares the collected biometric data to the registered biometric data;
if the biometric data matches, the user is authenticated, and the drone system proceeds with the order pickup and delivery process;
if the biometric data does not match, access is denied, and the user is prompted to retry authentication;
enable the drone to autonomously pick up products from the multiple vendor locations as specified in the uploaded purchase orders, and deliver them to the user's designated address.

10. The computing system of claim 8, wherein the instructions to authenticate the biometric data further comprise:
instructions to retrieve the registered biometric data from a secure repository;
instructions to compare the collected biometric data with the registered data to verify the user's identity.

11. The computing system of claim 8, wherein the biometric authentication system is configured to process fingerprints, facial recognition, or other biometric modalities to authenticate the registered user.

12. The computing system of claim 8, wherein the drone system is configured to allow the user to specify custom delivery preferences, such as preferred time of day or delivery location.

13. The computing system of claim 8, wherein the drone is equipped with sensors to detect obstacles during its flight, allowing for automatic re-routing to avoid collisions.

14. The computing system of claim 8, wherein the drone is further configured to deliver a confirmation notification to the user once the package has been successfully delivered to the specified address.

15. A computer-implemented method, the method comprising:
configuring a personalized autonomous drone delivery system for a registered user, wherein the system allows the user to place orders for products from multiple vendors and upload purchase orders for product pickup;
assigning biometric access credentials to the system, wherein the biometric access credentials are based on registered biometric data specific to the user;
authenticating the user by verifying the collected biometric data, wherein:
system receives an access request from the user's remote device requesting access to the drone delivery system;
system compares the collected biometric data to the registered biometric data;
if the biometric data matches, the user is authenticated, and the drone system proceeds with the order pickup and delivery process;
if the biometric data does not match, access is denied, and the user is prompted to retry authentication;
uploading purchase orders from multiple vendors, wherein the orders include product details and geospatial information, to the drone system;
enabling the autonomous drone to collect products from the vendor locations as specified in the uploaded purchase orders and deliver the products to the user's designated address.

16. The computer-implemented method of claim 14, wherein the drone autonomously navigates to the vendor locations based on the uploaded purchase orders, optimizing the flight path for efficiency and safety by considering environmental factors such as airspace restrictions and weather.

17. The computer-implemented method of claim 14, wherein the drone is configured to use an autonomous navigation system that adapts to environmental conditions and obstacles, ensuring safe and efficient travel from the vendors to the user's location.

18. The computer-implemented method of claim 14, further comprising:
receiving real-time notifications from the vendors about product availability, and updating the drone system with this data before initiating the pickup.

19. The computer-implemented method of claim 14, wherein the drone system is configured to adjust the delivery schedule in real-time based on the availability of the products from the vendors.

20. The method of claim 14, wherein the biometric authentication system supports multi-modal authentication, including fingerprint, facial recognition, and voice recognition to increase system security.
